(19) United States
(12) Patent Application Publication
(10) Pub. No.: US 2008/0119978 A1
(43) Pub. Date: May 22, 2008

(54) Method and Apparatus For Wheel Assembly Force Moment Arm Measurement

(75) Inventors: Michael T. Stieff, Wentzville, MO (US); Leigh R. Burns, Troy, IL (US); Daniel R. Dorrance, Ballwin, MO (US); Thomas J. Golab, St. Peters, MO (US); Mark S. Shylanski, University City, MO (US)

Correspondence Address: POLSTER, LIEDER, WOODRUFF & LUCCHESI, 12412 POWERSCOURT DRIVE SUITE 200, ST. LOUIS, MO, 63131-3615, US

(73) Assignee: HUNTER ENGINEERING COMPANY, Bridgeton, MO (US)

(21) Appl. No.: 11/942,504

(22) Filed: Nov. 19, 2007

Related U.S. Application Data
(60) Provisional application No. 60/866,537, filed on Nov. 20, 2006.

(51) Int. Cl. G01M 17/013

(52) U.S. Cl. 701/29

(57) ABSTRACT

A machine vision vehicle wheel alignment system configured to measure non-traditional vehicle wheel alignment angles and to determine dynamic behavior of a vehicle suspension system by observing optical targets or visible features, attached to points of interest on the vehicle body or vehicle wheels. The vehicle wheel alignment system characterizes the suspension geometry with respect to the body of the vehicle and to a rolling surface by measuring, in three-dimensions, points and/or angles on the vehicle body as well as the vehicle wheels, enabling measurement of specific non-traditional vehicle parameters, including wheel assembly braking force and lateral force moment arms.

### CROSS-REFERENCE TO RELATED APPLICATIONS

The present application is a non-provisional of, and claims priority from, U.S. Provisional Patent Application Ser. No. 60/866,537 filed on Nov. 20, 2006, which is herein incorporated by reference.

### STATEMENT REGARDING FEDERALLY SPONSORED RESEARCH

Not Applicable.

### BACKGROUND OF THE INVENTION

The present invention is related generally to methods for vehicle wheel alignment, and in particular, to advanced methods for measuring non-traditional vehicle wheel alignment and suspension geometry measurements such as angles or distances including a wheel assembly braking force moment arm and lateral force moment arm.

In the wheel alignment industry the advanced measuring capabilities of machine vision alignment systems have not been fully utilized. Traditional vehicle wheel alignment angles include camber, caster, toe, thrust line, and vehicle centerline measurements. However, there are many non-traditional vehicle wheel alignment and suspension system measurements that are of interest to those involved in suspension system adjustment, modification or reconstruction that are not measurable with prior art vision alignment systems and measurement methods. Those alignment systems provide adequate basic or traditional alignment information enabling stock vehicles to be configured to achieve their designed stability and long tire life with low rolling resistance.

Nominally, these conditions are met as long as the vehicle suspension has tight joints and no deformed members or intentional modifications. When abnormal conditions arise, alignment system diagnostic capabilities become important for efficient and correct problem solutions. Enhancing the diagnostic capability requires the alignment system to provide measurements of angles and distances that go well beyond the traditional ability of prior art alignment systems. Alignment measurements provided by prior art alignment systems are based on the vehicle usually sitting in a static condition. It is generally assumed that if the statically determined measurements are correct that the dynamic conditions will be ideal. This may not be the case as a vehicle which has been properly statically aligned may exhibit a pull or bump steer during the road test. Diagnosis of the problem at this point may be very time consuming as the alignment system has only provided static and not dynamic information about the behavior of the suspension system. Lack of dynamic diagnostic data could result in compensating the wrong suspension angle to correct the problem or needlessly replacing parts. In addition, prior art alignment systems have very limited capability to assess the changes introduced in the suspension system when stock designs are modified by changing wheels and tires or raising or lowering the body height. These modifications usually create changes in the dynamic characteristics of the vehicle.

Accordingly, it would be advantageous to provide a vehicle wheel alignment system, such as a machine-vision vehicle wheel alignment system, with the capacity to measure non-traditional angles and distances related to vehicle dynamics, in particular, those non-traditional angles and distances which have previously been un-measurable using traditional vehicle wheel alignment systems such as those with conventional wheel mounted angle transducers. These measured non-traditional angles and distances may be utilized to diagnose difficult handling problems and/or to determine the desirability of modified or customized configurations of the vehicle which depart from the standard configuration. Exemplary discussion of non-traditional angles and distances associated with automotive vehicle chassis and suspension systems may be found in REIMPEL, STOLL, BETZLER: “The Automotive Chassis: Engineering Principles” 2^{nd} Ed., published on behalf of the Society for Automotive Engineers, Inc., Warrendale, Pa. in 2002 an assigned ISBN 0 7680 0657 0.

Prior art machine vision wheel alignment systems provide traditional static measurements which relate the pointing direction of the vehicle wheels to each other and to the rolling surface (toe and camber angles) and a dynamic measurement of the steering axis position and orientation. The steering axis orientation is resolved into steering axis inclination (SAI) and caster components or the components can be measured and the steering axis orientation constructed. At least one prior art system attempts to provide some information about the dynamics of the vehicle steering system by supplying two distances related to the relationship between the center of the tire contact patch and the point where the steering axis pierces the rolling surface. While these distances are of interest, many more non-traditional measurements related to the vehicle dynamics are available when the machine vision wheel alignment system is properly configured with the appropriate hardware and software.

### BRIEF SUMMARY OF THE INVENTION

Briefly stated, the present disclosure provides a vehicle wheel alignment system with the capability to make non-traditional vehicle wheel alignment and suspension geometry measurements in order to determine dynamic behavior of a vehicle suspension system. The vehicle wheel alignment system is configured to characterize the suspension geometry with respect to the body of the vehicle as well as to a rolling surface by measuring in three dimensions, points and/or angles on the vehicle body as well as the vehicle wheels. The vehicle wheel alignment system may observe targets, attached to the points of interest on the vehicle body, or may observe a separate area of interest in a field of view to measure a point on the vehicle body. The acquired vehicle body measurements enables a characterization of the vehicle suspension system. This characterization of the vehicle suspension system is achieved by acquiring body position information in conjunction with the three dimensional positions of the axis of rotation for the individual vehicle wheels, steering axis, and rolling surface, including traditional wheel alignment angles, enabling measurement of a wide range of non-traditional vehicle wheel alignment and suspension angles and distances.

The foregoing features, and advantages set forth in the present disclosure as well as presently preferred embodiments will become more apparent from the reading of the following description in connection with the accompanying drawings.

### BRIEF DESCRIPTION OF THE SEVERAL VIEWS OF THE DRAWINGS

In the accompanying drawings which form part of the specification:

FIG. 1 is a perspective illustration of prior art camera placement for measurement of wheel center and tire tread width;

FIGS. 2A-2C illustrate dimensions and measurements associated with a prior art wheel rim;

FIG. 3 illustrates the identification of tire tread midpoints in an image of a wheel;

FIG. 4 illustrates a wheel disk model perpendicular to an axis-of-rotation;

FIG. 5 represents a fitting of tire tread midpoints to a wheel disk model;

FIG. 6 illustrates a model of a tire contact patch;

FIG. 7 illustrates the tire contact center and axle height of a vehicle wheel;

FIG. 8 illustrates the static loaded radius of a vehicle wheel;

FIG. 9 illustrates rolling movement of a wheel assembly from which an effective tire circumference may be calculated;

FIG. 10 illustrates the braking force moment arm of a vehicle wheel;

FIG. 11 illustrates the longitudinal force moment arm of a vehicle wheel;

FIG. 12 illustrates the lateral force moment arm of a vehicle wheel;

FIG. 13 illustrates positive and negative caster offset of a vehicle wheel;

FIG. 14 illustrates how the positions of the Axis Of Rotation (AOR) vectors and positions of the piercing point are used to determine a position of the steering axis;

FIG. 15 represents the track circle radius of a turning vehicle;

FIG. 16 is an alternative illustration of the track circle radius of a turning vehicle;

FIG. 17 illustrates vehicle body reference lines;

FIGS. 18 and 19 illustrate vehicle body roll reference measurements;

FIG. 20 is an illustration of a track alteration angle for a vehicle wheel;

FIG. 21 illustrates the geometry for locating the roll center of a vehicle wheel with an SLA type suspension;

FIG. 22 is illustrates the geometry for locating the roll center of a vehicle wheel with a McPherson strut;

FIG. 23 illustrates the steering geometry changes for a vehicle wheel in response to the position of the inner joint of the tie rod or rack and pinion;

FIG. 24 is a graphical representation of the effect of a miss-location of the inner joint of the tie rod or rack and pinion;

FIG. 25 illustrates the vehicle in its steered ahead reference position for computing roll steer;

FIG. 26 illustrates the change in vehicle steer angle with body roll;

FIG. 27 is a plot of body roll angle on the vertical axis against steering angle on the horizontal axis;

FIGS. 28-30 illustrate vehicle component relationships associated with center of gravity calculations;

FIG. 31 illustrates the geometry for determining the linkage ratio for a spring associated with a vehicle wheel suspension system;

FIGS. 32 and 33 illustrate the geometrical concepts for vehicle anti-dive measurements;

FIGS. 34 and 35 illustrate the geometrical concepts for vehicle anti-squat measurements; and

FIG. 36 represents the geometry associated with a wheel contact radius.

Corresponding reference numerals indicate corresponding parts throughout the several figures of the drawings. It is to be understood that the drawings are for illustrating the concepts set forth in the present disclosure and are not to scale.

### DESCRIPTION OF THE PREFERRED EMBODIMENT

The following detailed description illustrates the invention by way of example and not by way of limitation. The description enables one skilled in the art to make and use the present disclosure, and describes several embodiments, adaptations, variations, alternatives, and uses of the present disclosure, including what is presently believed to be the best mode of carrying out the present disclosure.

A variety of non-traditional measurements associated with a vehicle may be acquired by a vehicle wheel alignment system of the present invention. The following discussion provides detailed descriptions of a selected set of non-traditional measurements, methods for acquiring the non-traditional measurements, and where appropriate, specific apparatus configurations for the vehicle wheel alignment system. It will be understood by one of ordinary skill in the art that the non-traditional measurements described herein are not intended to be limiting, and that additional non-traditional measurements may be acquired without departing from the scope of the invention. Furthermore, since these are non-traditional measurements within the field of vehicle alignment, the same measurements may be know by different names.

In general, machine vision vehicle wheel alignment systems typically use a solid state camera with an array detector mounted away from the vehicle to obtain an image of a wheel mounted target. The target incorporates an accurately reproduced pattern that has known control features, as set forth in U.S. Pat. No. 6,064,750, herein incorporated by reference. The position of the features in the image are found and the orientation of the wheel can be calculated by well known algorithms.

Some machine vision systems do not use a predefined target but identify either random or predetermined geometric features or points of interest directly on the vehicle component, or on a wheel or tire of a wheel assembly, such as projected light stripes or the circular wheel rim, and use the distortion of the geometry to determine positions and orientations. The methods and apparatus of the present invention may be utilized with a wide variety of machine-vision vehicle wheel alignment systems, including those with removable targets and those without, which rely instead on observation of visible points of interest or features on the vehicle or vehicle component in a field of view.

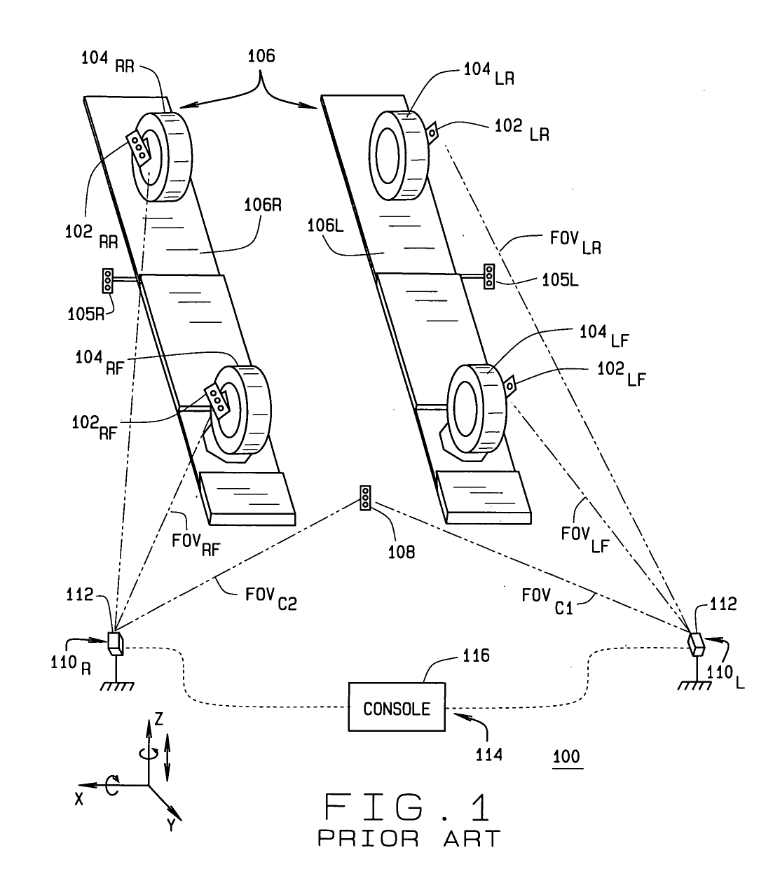

Turning to FIG. 1, an exemplary machine vision vehicle wheel alignment system 100 is shown configured with a multi-camera configuration. The machine vision vehicle wheel alignment system 100 includes a set of conventional optical targets 102_{LF}, 102_{RF}, 102_{LR}, and 102_{RR}, mounted to the wheels 104_{LF}, 104_{RF}, 104_{LR}, and 104_{RR} of a vehicle in a conventional manner. The wheels 104 may be either on the runways 106L and 106R of a runway system 106 such as a lift rack or service pit, or disposed on the ground or other fixed and substantially level surface.

To obtain images of the optical targets 102, a pair of independently positioned camera systems or sensor heads 110_{L} and 110_{R} are preferably disposed in front of, and adjacent to, the left and right sides of the vehicle position. Alternatively, those of ordinary skill in the art will recognize that the camera systems or sensor heads 110 may be disposed elsewhere about the vehicle as required to view the optical targets 102 and the wheels 104. One or more cameras 112 are disposed in the camera system or sensor head 110_{L}, and have fields of view FOV_{LF}, FOV_{LR}, and FOV_{C1} which generally encompass the optical targets 102_{LF}, 102_{LR} and the associated wheels 104. Correspondingly, one or more cameras 112 are disposed in the camera system or sensor head 110_{R} and have fields of view FOV_{RF}, FOV_{RR}, and FOV_{C2} which encompass the optical targets 102_{RF}, 102_{RR}, and the associated wheels 104. Each camera system or sensor head 110 is optionally adjustable about a vertical axis Z to accommodate vehicles and runway systems of different heights, and is optionally translatable along a horizontal axis X, or rotatable about the vertical axis Z to accommodate vehicles having different track widths, whereby the optical targets 102 can be located optimally within the associated fields of view.

Those of ordinary skill in the art will recognize that the number of cameras 112 disposed in each camera system or sensor head 110 may be varied, provided that images of each optical targets 102 and the associated wheels 104 are obtained and processed by the machine vision vehicle wheel alignment system 100. When multiple cameras 112 are disposed in each camera system or sensor head 110, the spatial relationships between each of the cameras 112 in the camera system or sensor head 110 may be either determined during manufacture, or prior to use as described in U.S. Pat. No. 5,724,128 to January herein incorporated by reference. These spatial relationships must remain constant between each determination.

The signals from the cameras 112 in each camera system or sensor head 110 are supplied to a computer or data processor 116 which may be disposed within the console 114. Those of ordinary skill in the art will recognize that the processing of images acquired by each of the cameras may be carried out in whole or in part by data processors located within the sensor heads 110, such that results are transferred to the computer or data processor 116, or alternatively, raw image data may be transferred to the computer or data processor 116 wherein all processing is carried out. The computer or data processor 116 is configured with software to utilize data from the acquired images to determine various wheel alignment angles and distances. The positional relationship, or coordinate system transformation, between the cameras 112 disposed in the left sensor head 110_{L}, and the cameras 112 disposed in the right sensor head 110_{R} is determined by the computer 116 utilizing a coordinate transformation between at least one of the cameras 112 on the left sensor head 110_{L} and at least one of the cameras 112 on the right sensor head 110_{R}. Since the relationships between each of the cameras 112 on the left sensor head 110_{L}, and optical targets 102 in the associated fields of view FOV are known, and corresponding information is also known for the cameras 112 in the right sensor head 110_{R} and optical targets 102 in the associated fields of view FOV, all measurements may be mathematically transformed into a single common coordinate system, and the alignment of the vehicle wheels determined. These mathematical transformations are well known to those of ordinary skill, such as shown in U.S. Pat. No. 5,724,128 to January.

Position of the Wheel Center

For each of a vehicle's wheels, it is useful to determine the three dimensional alignment system coordinates for a wheel center. The wheel center is the point along the wheel's axis-of-rotation that lies midway between the outer and inner wheel rim planes. Knowledge of the position of the wheel center can be used to help compute other measurements that more directly affect the performance characteristics of a vehicle's steering and suspension. Techniques and apparatus for determining the wheel axis-of-rotation in three-dimensional alignment system coordinates using a machine vision wheel alignment system are known, and are described in U.S. Patent Application Publication No. 2007/00680016 A1 to Stieff et al. for “Method and Apparatus for Vehicle Service System Optical Target Assembly”, herein incorporated by reference.

In one embodiment, the coordinates of the wheel center can be obtained by starting at the point where the wheel axis-of-rotation pierces an optical target disposed on the vehicle wheel, and projecting towards the vehicle body along the axis-of-rotation for an appropriate distance. The projection distance is the sum of several components. The projection components include the distance from the optical target face to the socket of a wheel adapter securing the optical target to the wheel, the distance from the wheel adapter's socket to the wheel's outer rim plane, and the distance from the wheel's outer rim plane to the wheel center. The first two distances can be determined from the known dimensions of the optical target and wheel adapter. The last component is equal to half the rim width, where the rim width is the distance between the inner and outer rim planes of the wheel.

Knowledge of the rim width can be obtained either by directly measuring the particular wheel, such as with a caliper gauge, or by referencing manufacturing dimensions via information engraved or electronically stored on the wheel. The rim width may also be determined using the tire size information located on the tire sidewall, such as using optical character recognition techniques as is described below. The measured or obtained rim width dimension can then be entered into an alignment software application via the keyboard of an alignment console, or acquired electronically through any suitable means.

OCR Capability to Read Tire Information

An aspect of the present invention enables acquisition of tire and wheel information by a machine-vision wheel alignment system. For some of the alignment measurements described herein, such as track width or scrub radius, it is important to know the width of the observed wheel rim from the inner bead seat to the outer bead seat, in addition to the wheel rim offset and/or backspacing. In one embodiment, the alignment equipment provides a way for the operator to manually enter this type of tire information. The entry may be associated with a measurement screen such as the track width measurement, an alignment procedure such as WinAlign Tuner™ sold by Hunter Engineering Company of Bridgeton, Mo., or it could have its own screen.

Wheel rim width and wheel rim diameter is fairly easy to measure but it can also be read from the stamping in the rim, or automatically transferred to the alignment system from another vehicle service device, such as a wheel balancer. Similarly, wheel rim offset or backspacing can sometimes be read from the stamping on the inside of the wheel rim (wheel must be off the vehicle in most cases) but it can always be measured directly.

In one aspect, the present invention improves upon the image processing carried out by machine vision wheel alignment systems by processing the acquired images to extract character and symbol information from the sidewall of the tire and wheel rim surfaces. This is commonly known as OCR (optical character recognition). The information taken from the tire and wheel rim can be used in multiple ways.

In one embodiment, alignment programs or software modules adapted for use with customized vehicles may be automatically activated on an alignment system if the alignment system determines that the size of the tires installed on the vehicle are different from the original equipment manufacturer tire specifications as identified in a vehicle database.

Similarly, the maximum tire pressure identified from the tire sidewall data using image recognition and OCR may be compared to the actual tire pressure measured by the vehicle wheel alignment system or another vehicle service device. A warning can be conveyed to the alignment technician if the maximum tire pressure is exceeded.

The maximum tire loading identified from the tire sidewall data using image recognition and OCR may be compared to the actual weight measured by the alignment equipment. A warning can be conveyed to the alignment technician if the maximum tire load is exceeded.

The tire sidewall information could be used to determine tire width and rim width. The rim width would correspondingly be used in the calculation of track width and breaking force moment arm.

If new wheels are being installed on a vehicle, the alignment system of the present invention may optionally provide an input interface which accepts the stamped identification of the rim. All domestic rims are required by NHTSA and the FMVSS (Federal Motor Vehicle Safety Standard) to be stamped as to the wheel rim diameter and wheel rim width, and may include markings identifying the rim contour and wheel offset. For instance, a marking of 15×6 J designates a 15 inch diameter wheel, 6 inch wide wheel from bead seat to bead seat, and a J contour wheel. The J designation is normally further designated by a designation which indicates a reference for the contour designation.

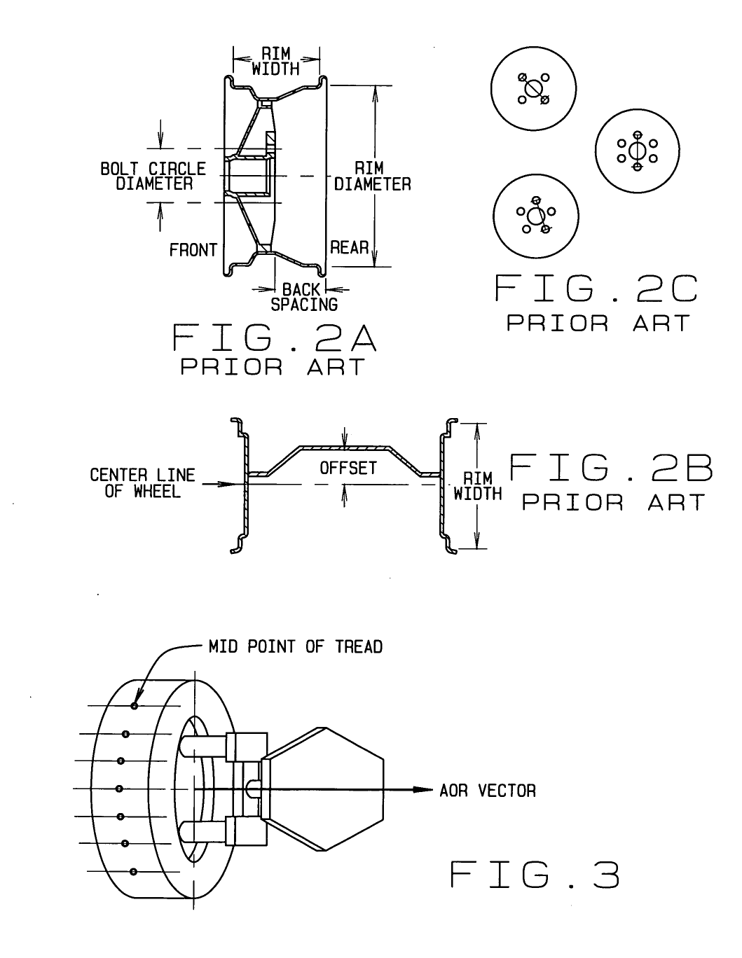

FIGS. 2A-2C illustrate a typical prior art wheel rim with important dimensions shown. Most of the measurements are best thought of from the perspective of the tire. The rim width is measured at the point where the bead of the tire contacts the wheel, same with the rim diameter. The bolt circle, shown in FIG. 2C, relates to the attachment point for the wheel and hub. Two figures are important, the diameter of the bolt circle and the number of bolts. For even number of bolts (4, 6, 8, etc) the diameter can be measured across two opposite holes, either center to center or edge to edge. For odd number of bolts (like 5), the diameter can be easily measured across two opposite holes, from the center of one to the outside edge of the other.

The back spacing measurement is critical in the fitment of the wheel (and tire) to the vehicle. Since the suspension, brake, steering and drive systems are typically located behind the wheel, the back spacing is used to define a volume behind the wheel where these items can exist.

A related term is known as offset, which relates the hub mounting surface to the centerline of the rim. A zero offset indicates the hub mounting surface is at the exact centerline of the rim. In this case, the back spacing would then be equal to ½ the rim width (plus the thickness of the bead lip on the rim—see below). Offset is measured such that positive offsets mean the inner lip of the rim is closer to the vehicle and negative offsets move the rim away from the vehicle. Offset is usually measured in millimeters (mm) and often has the designation “ET” prepended to the offset, so a 19 mm offset may be listed as ET19. Note that offset and backspacing are related but measured at slightly different points.

Backspacing and offset are two different measurements of essentially the same thing, however they are opposite in sign. A greater amount of backspacing means the wheel sits in closer to the axle and that less of the wheel's width will appear outside of the wheel mounting flange, giving a narrower track. A greater amount of offset means the wheel mounting flange is closer to the inside of the wheel so consequently more of the wheel's width is to the outside, giving a wider track.

Apparatus and Method to Determine Wheel Center

As shown in FIG. 1, the position of a wheel center may be determined directly using a camera or imaging system that views an optical target and the associated wheel assembly. The relationship between the primary alignment cameras and the camera measuring the wheel center may be predetermined using methods already known in the art. It should also be noted that it is feasible for the camera measuring the wheel center to only view the individual wheel, and relate all its measurements to a common coordinate system for the method described below.

FIG. 3 shows a view of the optical target and wheel assembly when determining a wheel center. The first step is to determine the midpoint of the tread in the image. This may be done by examining horizontal strips across the wheel assembly and finding the edges of the tire tread in the resulting images. The midpoints are half way between the edges of the tire tread.

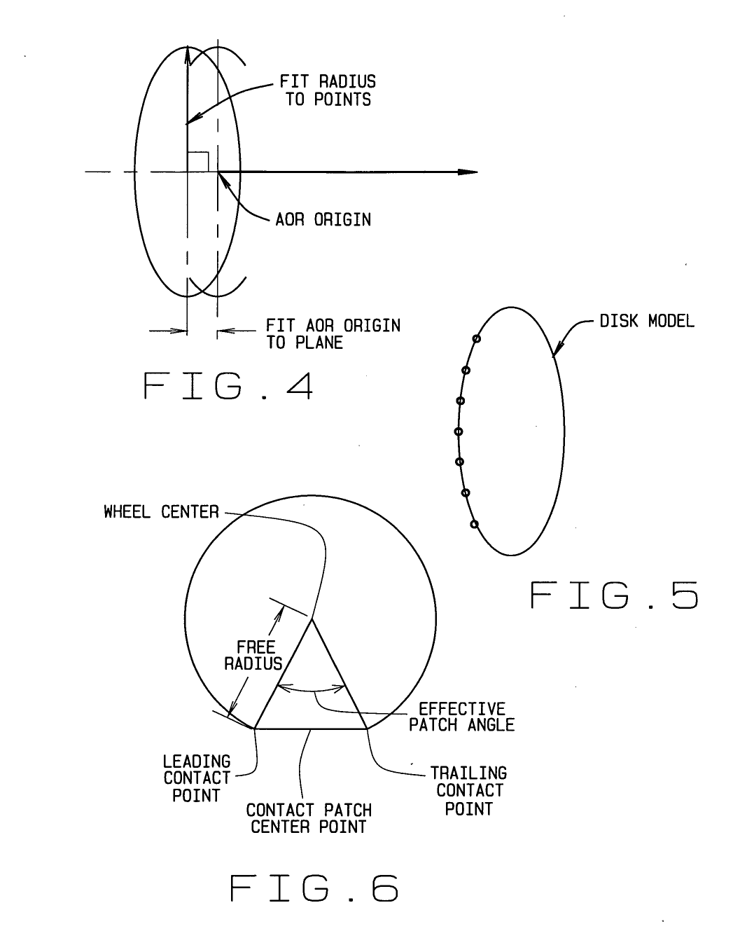

As shown in FIG. 4, the middle of the wheel assembly is then modeled as a disk perpendicular to the Axis Of Rotation (AOR) vector that was previously determined. At this point the radius of the disk and its origin point along the AOR vector are unknown.

The next step, shown in FIG. 5, is to perform an optimization that will adjust the radius and origin of the disk in order to determine the best fit between the edge of the disk and tire tread midpoints that were previously measured. The origin of the disk is the wheel center.

When a vehicle is resting upon a supporting surface, such as a road, service bay floor, or vehicle lift rack runway, the wheel assemblies are bearing the weight of the vehicle. Pneumatic tires, as a typically found on wheel assemblies of most automotive vehicles, deform under load, flattening to conform to the supporting surface, as shown in FIG. 6. This flattened portion of the tire or wheel assembly is commonly referred to as the contact patch of the wheel assembly, and is defined by a leading contact point, a trailing contact point, and a tire contact patch center point disposed mid-way between the leading and trailing contact points, with an arcuate distance between vectors from the wheel center to the leading and trailing contact points defining the effective patch angle. Due to the distortion, the wheel assembly behaves during rolling movement, as if the circumference of the wheel assembly or tire has been reduced from that which would be measured in an unloaded or “free” state.

Position of Tire Contact Center

Knowledge of the location of the tire contact patch center point facilitates computation of various lever arm lengths over which driving forces apply torque to the steering axis. When a vehicle wheel rests on a surface, the contact center of the tire, shown in FIG. 7, lies on the rolling surface. Conceptually, the tire contact center can be located by intersecting the plane of the rolling surface with a line originating at, and perpendicular to, the axis of rotation of the wheel, and going in the downward direction through the midpoint of the rim width as shown in FIG. 7.

The actual point of application of the road forces moves away from the contact center when the vehicle is moving. Therefore, the measured contact point may optionally be replaced in calculations with an estimated center of force point based on test data for high speed cornering and/or braking. This may be useful when evaluating the effects of a wheel with a different diameter, width, or offset than the OEM wheel. The direction vector from the wheel center toward the contact center point can be obtained by first obtaining a longitudinal vector by performing the cross product of the axis-of-rotation vector with a vertical vector, and then performing a cross product of the longitudinal vector with the axis-of-rotation.

As shown in FIG. 8, the distance between the wheel center and the contact center is known as the Static Loaded Radius. It is the hypotenuse of a tall, narrow right triangle, whose height is known as the Axle Height. In the presence of a non-zero camber angle, Static Loaded Radius differs from the Axle Height by a ratio equal to the cosine of the camber angle. This invention envisions several ways of computing the location of the contact center point. Some of these are based on determining coordinates of the rolling surface. Others are based on modeling the deformation of the tire under load.

Obtaining Tire Contact Center from Rolling Surface Location

There are several ways to determine the alignment system coordinates of the plane of the rolling surface. Many alignment systems involve stationary machine vision cameras and a lift-rack such that the altitude of the rolling surface can be set to any one of a set of identifiable, repeatable rack heights. The coordinates of the rolling surface plane for a particular lift-rack height can be determined by observing machine vision targets mounted on a calibration bar fixture that rests on the rolling surface during a calibration procedure. Later use of rolling surface coordinates would depend upon the alignment system knowing which of the discrete lift-rack positions is currently in use. That information could be conveyed either with the help of a human operator, or by sensing mechanisms built into the lift-rack. Another way to determine the coordinates of the rolling surface is to observe machine vision targets mounted on the lift-rack, near its rolling surface, such as shown in FIG. 1 and in U.S. Published Application No. 2005/0078304 A1 to Dorrance et al. for “Common Reference Target Machine Vision Wheel Alignment System” which is herein incorporated by reference

A computation described earlier provides the direction vector from wheel center to tire contact center. Once the coordinates of the plane of the rolling surface are known, one can find the tire contact center by starting at the wheel center and projecting along the direction vector until the rolling surface plane is reached.

Obtaining Tire Contact Center from a Model of Tire Deformation

FIG. 6 shows how a tall isosceles triangle can be formed in the side view (longitudinal plane) of a tire by observing vertices at the wheel center and the leading and trailing contact points of the tire contact patch. This triangle illustrates the relationship between the length of the contact patch and the Free Radius or Unloaded radius of the tire. The relative magnitudes of those lengths can be determined from knowledge of the Effective Patch Angle as shown in FIG. 6. The Effective Patch Angle for a tire under normal load and properly inflated is approximately the same across many vehicles sharing the same broad class of tire. For example, an industry rule-of-thumb suggests that the loaded radius of a steel-belted radial tire is 92% of the unloaded radius; therefore, solving the isosceles triangle allows identifies that such tires will have an Effective Patch Angle of approximately 46 degrees.

The location of the tire contact patch center point can be estimated by applying the above model of the deformation of the tire under load along with knowledge of the wheel center, axis-of-rotation, and an estimate of the unloaded radius of the tire. From the wheel center, a pair of vectors can be constructed that lead to the leading and trailing contact points. The vector lengths will each equal the estimate of the unloaded or “free” tire radius. The vector directions can be determined from knowledge that they lie in the wheel assembly centerline plane (which is perpendicular to the wheel assembly axis-of-rotation), and that they straddle the ray from wheel center to contact center with a separation equal to the Effective Patch Angle. The contact center point can be computed as the mid-point of the leading and trailing contact points.

Obtaining Unloaded Tire Radius

The above contact center computation presumes having an estimate of the unloaded radius of the tire. One way of obtaining this is by consulting the manufacturer's specification for the particular tire, possibly inferred by interpreting the coded numbers embossed upon the tire sidewall. A second way is to compute the unloaded radius from the effective circumference that can be determined from observing the vehicle roll on the alignment lift-rack. The ratio between the effective circumference and the unloaded radius is approximately equal for broad classes of tires. Because of the elastic behavior of a rolling rubber tire, this ratio does not match the normal ratio of the circumference of a circle to its radius. For example, the effective circumference for steel-belted radial tire, under normal load and pressure, can be expected to be approximately equal to 6.16 times the unloaded radius of the tire.

Obtaining Tire Contact Center from Effective Circumference

The effective circumference of a tire can be computed from observing the vehicle rolling on the alignment rack. The position and attitude of machine vision targets can be measured at a series of intermediate positions as the vehicle is rolled a short distance. For any particular pair of intermediate positions, the ratio of the change in forward translation to the change in target rotation represents the rolling rate of the wheel. When a series of such rolling rate values are averaged and scaled, an estimate of the effective circumference of the tire is obtained.

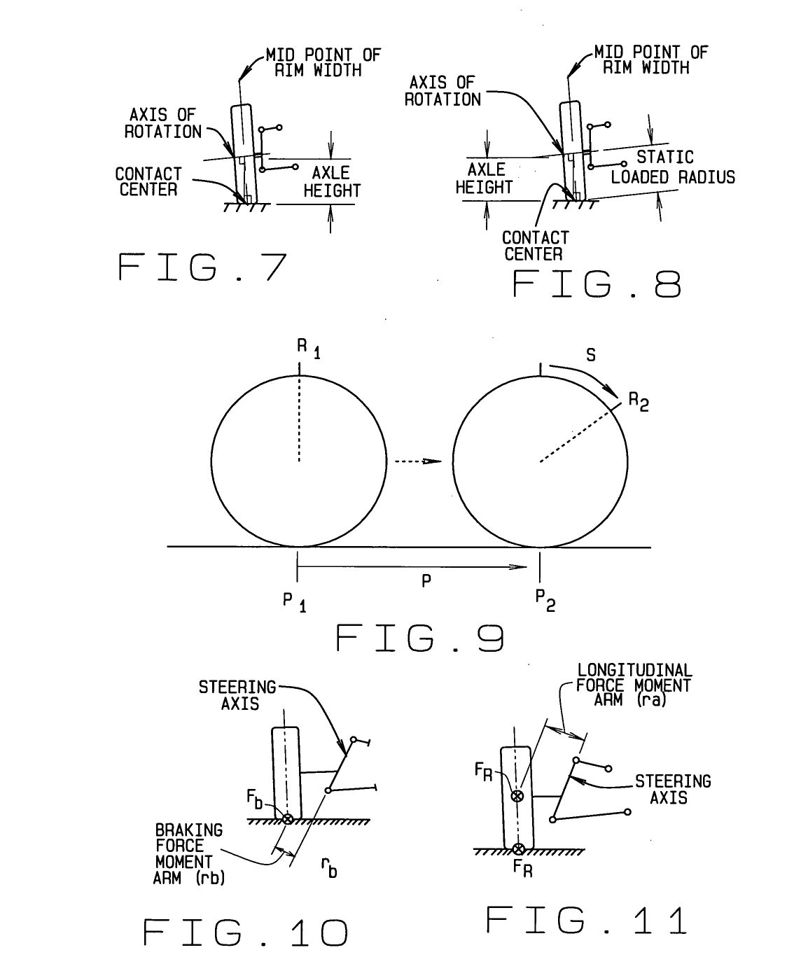

Utilizing a machine vision vehicle wheel alignment system 100, the effective circumference of a tire or wheel assembly 104 can be computed by observing rolling movement of the wheel assembly 104, such as during a rolling compensation procedure used to determine the axis of rotation for wheel-mounted optical targets 102. The position and attitude of the machine vision targets 102 secured to the wheel assemblies 104, or other identifiable features of the wheel assembly, are measured at two discrete positions P₁ and P₂, or at a series of intermediate positions, Pₙ, Pₙ₊₁ as the vehicle is rolled a short distance P. For any particular pair of positions, or an initial position and a final position, the ratio of target translational movement between the positions, to the target rotational movement which corresponds to the rotational movement of the wheel assembly 104 between the first and second positions, represents the rolling rate of the wheel assembly. The effective tire circumference (ETC) is then obtained according to the following formula:

$$ETC = \frac{360 \times P}{δ}$$

where P is a measure of the translational movement of the wheel assembly during the rolling process, and δ is a measure of the amount of rotation of the wheel assembly during the same rolling process, shown as the arcuate distance between R₁ and R₂ in FIG. 9. By averaging and scaling a series of ETC measurements, such as may be obtained over a series of intermediate wheel positions during rolling movement, an accurate estimated ETC value may be obtained for the wheel assembly.

Knowledge of the effective tire circumference allows various properties of a wheel assembly, including the wheel's dynamic radius to be subsequently determined. A wheel's dynamic radius is known to be slightly larger than an observed static loaded radius. The ratio of these radii is a function of the mechanical characteristics of the tire. Approximate values for this ratio may be identified that are usable for broad classes of tires. For example, it is useful to assume that the dynamic radius of a steel-belted radial tire is 1.065 times larger than the static loaded radius of the same tire when properly inflated. Similarly, one can assume that the dynamic radius of a bias-ply tire is 1.021 times larger than the static loaded radius of the same tire when properly inflated. An innovative technique, therefore, can involve building up a table listing the ratio of effective circumferences to static loaded radii for a various classes of tires. When working with a specific vehicle, the effective tire circumference for each wheel is measured by observing the rolling movement of the vehicle, and then the appropriate ratio from the predetermined table is applied to obtain the static loaded radius value for each vehicle wheel. The resulting value is an approximation, and yet it is typically more accurate than a computation that assumes that dynamic radius and static loaded radius are equivalent. Once a static loaded radius is known, various vehicle characteristics, such as axle height, can be determined at each wheel assembly.

Steering Axis

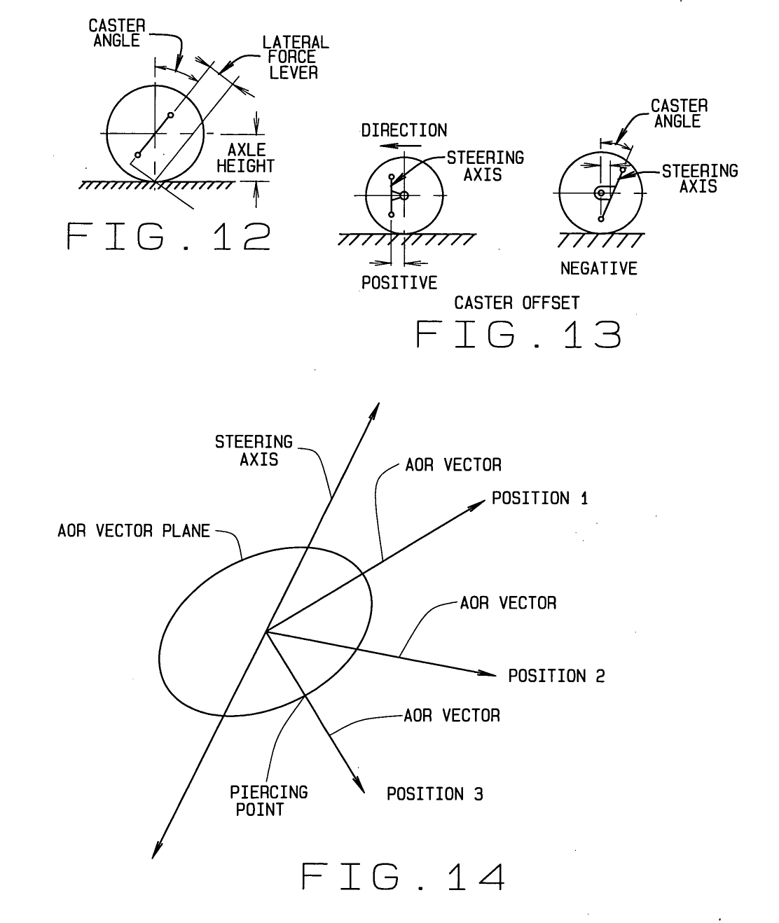

Estimating the location and attitude of the steering axis of a steered wheel assembly provides data which may be utilized in determining several non-traditional vehicle wheel alignment measurements, and facilitates computing various geometric characteristics of the vehicle's steering and suspension. These characteristics include the values of the following quantities which affect vehicle handling: Braking Force Moment Arm (FIG. 10), Longitudinal Force Moment Arm (FIG. 11), Lateral Force Moment Arm (FIG. 12), and Caster Offset (FIG. 13). One procedure for obtaining an estimate of the steering axis for a wheel assembly utilizes data gathered as the vehicle is steered while resting on an alignment lift-rack. Optical targets mounted to each of the vehicle's wheels are observed during the steering movement, and images are acquired for at least three different points during the steering action. One image is preferably acquired when the vehicle's front wheels are steered straight ahead. The second image is preferably acquired with the vehicle's wheels steered to the left by a moderate amount such as 20 degrees. Finally, the third image is acquired with the vehicle's wheels steered to the right by a moderate amount such as 20 degrees.

Alignment lift-racks are equipped with turn plates and slip plates that allow the footprint of each tire to freely slide or rotate within a horizontal plane. Because of this, the body of the vehicle can slide horizontally or rotate about a vertical axis while the steering is exercised. Steering action may also cause the vehicle body to undergo a small pitching and/or rolling motion. Preferably, the vehicle body motion must not be allowed to disrupt the computation of the estimates, so the method of the present invention defines a special coordinate system, called Body Thrust Coordinates, whose axes move in response to the horizontal motion of the vehicle.

The Body Thrust Coordinate System has its origin at a point mid-way between the centers of the two machine vision targets that are mounted on the rear wheels of the vehicle. The Z axis points upward, normal to the alignment system's horizontal reference plane. The Y axis lies in the horizontal plane and points in the same direction as the vehicle's thrust vector. The X axis generally points from left to right, and is perpendicular to the other two axis. For the purpose of analyzing the steering axes, the relationship between the Body Thrust Coordinate System and the machine vision cameras is re-computed for each of the three steering snapshots. The target locations at each snapshot are transformed into Body Thrust Coordinates for further computation.

For most vehicles, the steering geometry is such that changing the steering angle tends to induce a small change in the vertical distance between the lower suspension ball joint and the tire's contact patch; this change in distance has the potential of lifting or lowering that corner of the vehicle by a small amount. If the ball joint altitude change is the same on both sides, the entire front end of the vehicle will pitch slightly, without changing the degree of spring compression. But when the ball joint altitude change differs from left to right, a differential change is spring compression occurs, along with a small amount of body roll.

Changes in front spring compression during a steering sweep complicate the process of estimating the location and attitude of the steering axis. Understanding of this effect can be enhanced by imagining a “virtual kingpin” connecting the upper and lower pivot points of the steering axis. One of the pivot points typically corresponds to a lower ball joint and the other pivot point typically corresponds to either an upper ball joint or the bearing at the top of a McPherson strut. In the most precise analysis, the virtual kingpin undergoes changes in both position and attitude as the spring compression changes; the virtual kingpin may have motion in all 6 possible degrees of freedom.

If no assumptions are made about the motion of the virtual kingpin due to spring compression changes during the steering sweep, knowledge of the target position and attitude during the acquisition of images does not constitute sufficient information to calculate the position of the steering axis. This method achieves a reasonable estimate of steering axis position by making some simplifying assumptions about the motion of the virtual kingpin during the steering sweep. Specifically, the method assumes that the attitude of the steering axis changes by a negligible amount during the sweep. It also assumes that the steering axis translation is negligible along the longitudinal and lateral axes. On the other hand, a vertical translation of the steering axis is expected and is fully accounted-for in the algorithm.

In this method, the computation of the attitudes of the left front and right front steering axes makes use of the two steered images, but not the straight-ahead image. For the left side of the vehicle, the attitude of the steering axis in vector form is obtained by applying a Schur decomposition technique to a pair of rotation matrices obtained from the homogeneous coordinates of the successive locations of the left front machine vision target, taken during the two steered snapshots. The analogous process is applied to determine the attitude of the right front steering axis.

In this method, the position of each steering axis is estimated using a Levenberg-Marquardt optimization. The optimization chooses the longitudinal and lateral coordinates of the point where the steering axis intersects a horizontal plane that includes the origin of the Body Thrust Coordinate System. The computation of error terms to drive the optimization is based on the assumption that the steering axis and all points on it translate only in the vertical direction. During each iteration, the prospective lateral and longitudinal coordinates of the point on the steering axis are combined with a vertical coordinate of zero to obtain a three-dimensional point. This point is transformed from Body Thrust coordinates to the coordinate system of the machine vision target. Since the vehicle's brakes are locked, it is assumed that the physical relationship between the virtual kingpin and the machine vision target mounted to the wheel remains the same during the steering sweep. Therefore the target coordinates of the axis point are the same at all acquired images. The algorithm then uses the snapshot-specific transforms between target coordinates and Body Thrust Coordinates to obtain the Body Thrust Coordinates of the prospective axis point at the time of the two remaining images.

If the prospective solution is good, then the Body Thrust Coordinates for the axis point at the three snapshot moments will have nearly identical lateral and longitudinal components. The method does not assume the vertical components should agree, since it anticipates that there may be significant vertical motion of the virtual kingpin as the spring compression changes. Error terms for driving the optimization are computed for both the lateral and longitudinal disagreement between the axis point coordinates of the straight-ahead snapshot and those of the two steered images. The optimization uses four error terms to refine two solution components, therefore solving an overdetermined system of simultaneous equations.

Once the optimization converges, the lateral and longitudinal coordinates from the solution are combined with a zero vertical coordinate to obtain the three-dimensional coordinates of a point on the steering axis. Knowledge of the attitude of the axis plus this one point on the axis completely defines the steering axis position for purposes of analyzing the vehicle handling consequences of the relationship between the tire contact patch and the steering axis.

Alternate Method for Determining Orientation and Position of Steering Axis:

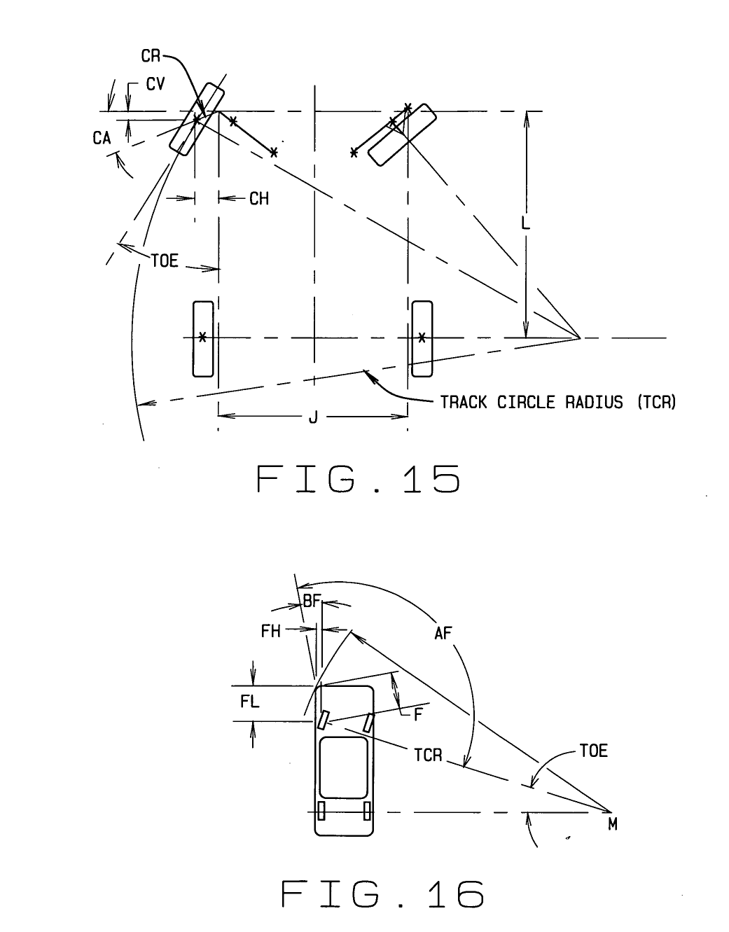

Another approach to estimate the position of the steering axis involves first locating the axis of rotation of the wheel and position where the axis of rotation pierces a wheel mounted optical target called the “piercing point”. This can be determined using prior art methods described in U.S. Patent Application Publication Serial No. 2007/0068016 to Stieff et al. Once the piercing point is identified, a steering procedure is performed where the vehicle is steered left and the right an appropriate amount (±10° is common). The alignment system represents the position and orientation of the wheel mounted optical target in translation components (Tx, Ty, Tz) and rotational components (Rx, Ry, Rz). Using math well known in the art, a direction vector representing the steering axis can be determined by using the optical target's rotational components. FIG. 14 illustrates how the positions of the Axis Of Rotation (AOR) vectors and positions of the piercing point in at least two positions may be used to determine a position of the steering axis. The AOR vectors define a plane around the steering axis, while the piercing points track a circular path around the steering axis. Using both the AOR vector plane and the center of the circular path of the piercing point, the steering axis can be located by an alignment system of the present invention. Using more than two steering positions will further enhance the system's ability to determine the position of the steering axis using standard optimization techniques well known in the art. This will help compensate for any uncertainty in the measurements due to noise. Using data from multiple positions would also provide some metrics that may indicate loose suspension linkages or warn parts. As an example of one such metric is the variation of where the AOR vectors from multiple positions intersect. Another possible metric is how closely the path of the piercing point matches a perfect circle in the steering axis co-ordinate system.

Performing a steering procedure in practice can sometimes cause the vehicle to move sideways on the slip plates. In order to compensate for this type of motion, additional targets (such as ride height targets) may optionally be attached to the vehicle body (such as at a fender). The alignment system of the present invention may then track the erroneous motion of the body targets and subtract this motion from the motion of the piercing point and AOR vectors. If there is too much body motion detected, a warning may be provided to the operator, enabling corrective actions (such as installing a brake pedal depressor) to be taken before repeating the steering procedure.

A further improvement of the present invention enable this method to be carried out with the vehicle jacked up by the frame. This prevents any motion of the body from adversely affecting the measurements. It further reduces any effects that may be caused by the motion of suspension components when the suspension is under a full load. In this case, the steering axis is determined relative to the target, so when the vehicle is let down off the jack, and the suspension is in its loaded position, the steering axis will still be known to the system. Although this procedure potentially would yield a more accurate steering axis, it would also require more steps and thus take more time. The operator would have the ability to choose the preferred procedure.

Further characterization of the steering axis may optionally be accomplished by performing this method under different loading conditions. The methods previously described could be performed with the vehicle fully jacked up, then again with the jack partially let down, then a number of times partially letting the jack down and then finally with the jack let down all the way. An effective steering axis position could be determined by averaging those results, or the movement of the steering axis could be characterized and extrapolated for other loading conditions.

Axle Height for a Vehicle Wheel

As previously shown in FIG. 7, the axle height for an individual vehicle wheel is defined as the length of a line segment originating at, and perpendicular to, a rolling surface on which a vehicle is disposed, and which terminates at the intersection point of a first line representing the axis of rotation of the vehicle wheel and a second line defining a contact center for the vehicle wheel. If the machine vision system is calibrated so that the position of the rolling surface is known, the axle height can be directly measured from the wheel axis of rotation. If the position of the rolling surface is not known, a close approximation of the axle height can be used. One method of approximation is to derive the axle height from the tire size with the inclusion of a tire deflection factor based on vehicle corner weight, inflation pressure and tire profile.

Right Triangle Involving Static Loaded Radius and Axle Height

If the camber angle of a wheel is not zero, a narrow right triangle is formed by the wheel center, the tire contact center and the projection of the wheel center down onto the rolling plane. The long, vertical side of this triangle is called the axle height, and the hypotenuse is the static loaded height (radius). When the camber angle is known, knowledge of either of two distances, axle height or static loaded radius, facilitates computation of the other distance by simply solving the right triangle.

Braking Force Moment Arm

With reference to FIG. 10, the distance, rb, is the braking force lever or moment arm. The braking force, Fb, is applied at the contact center in the direction of the thrust line of the vehicle and in the plane of the rolling surface. The shortest distance between the two non-coplanar vectors, Fb, and the steering axis is the braking force lever or moment arm, rb.

Longitudinal Force Moment Arm

FIG. 11 shows the longitudinal force lever or moment arm, ra. It is the shortest distance between the vector representing the rolling resistance and the steering axis, i.e. it is the shortest distance between the center of the wheel and the steering axis, both projected onto the lateral vertical plane of the vehicle. The rolling resistance vector is applied at the center of the wheel and in the direction of the thrust line of the vehicle. The rolling resistance force of the wheel acts at a distance from the steering axis known as the longitudinal force moment arm to create a couple or turning moment about the steering axis. Under ideal conditions, the turning moment on the left and right sides of the vehicle will be equal and opposite. When the moments get sufficiently out of balance the vehicle will tend to steer or pull to the side with the highest value. The out-of-balance condition may be due to the longitudinal force moment arms not being equal from side to side or the rolling resistance forces not being equal. Measurement of the individual longitudinal force moment arms can be used to calculate one component of the torque on the steering axis that results from rolling resistance force and may assist to isolate and correct the cause of a pulling condition. Equal moment arms indicate a tire problem while un-equal moment arms indicate a vehicle problem.

Lateral Force Moment Arm

The length, ntk, shown in FIG. 12, is known as the lateral force lever. It is the shortest distance between the steering axis, projected on to the longitudinal plane of the vehicle, and the contact center projected on to the same plane. The length of the lateral force moment arm has a direct impact on vehicle stability. The longer the moment arm the greater the restoring force when the wheel is disturbed from straight line travel by impact with a road hazard. While long moment arms are desirable for stability they also will create a higher feedback force to the steering wheel when turning or traversing roads in poor condition. The important parameter for the lateral force moment arm is that they are the same length side-to-side. This ensures that steering effort, camber and caster gain are symmetrical in right and left turns and provides predictable handling of the vehicle.

Rolling Resistance Moment Arm

The rolling resistance moment arm is the shortest distance between the vector representing the rolling resistance and the steering axis. The rolling resistance vector is applied at the center of the wheel and in the direction of the thrust line of the vehicle. This moment arm can be used to calculate the torque on the steering axis that results from rolling resistance force. FIG. 11 shows the rolling resistance moment arm as ra in the special case where steering axis caster is zero and toe of the wheel is zero.

Caster Offset

The caster offset distance is illustrated in FIG. 13. The steering axis is projected onto the longitudinal plane of the vehicle to show the caster angle. If the axis of the wheel does not intersect the projected steering axis the difference in the horizontal direction is the caster offset, rtw. The caster offset is positive if the wheel axis is behind the steering axis and negative if the wheel axis is in front of the steering axis.

Track Circle Radius

The track circle radius (TCR) of a vehicle is shown in FIG. 15 and FIG. 16. The tract circle radius can be computed for any steering angle by the formula:

$$TCR = \frac{( L - CV )}{sin ( TOE )}$$

where:

L=distance from the steering axis intersection with the rolling surface to the rear axle.

CV=CR*SIN(CA)

TOE=The toe angle of the front wheel on the outside of the turn.

Swept Turning Circle

FIG. 16 further illustrates the diameter of the smallest cylindrical envelope in which the vehicle can turn a circle with the largest steering input angle. Dimensions FL and FH can be obtained with an alignment system of the present invention by using the ride height target placed at the front bumper location or by manually inputting tape measure readings. The calculations proceed as follows:

$$F = \sqrt{( {FL}^{2} + {FH}^{2} )}$$

$$BF = a tan ( FH / FL )$$

$$AF = BF + 90 + TOE$$

$$Dtc = 2 * \sqrt{( {F}^{2} + {TCR}^{2} - 2 * F * TCR * cos ( AF ) )}$$

Curb-to-Curb

Using an alignment system of the present invention, a Curb-to-Curb turning diameter can be derived from the track circle radius by:

Curb-to-Curb=2*TCR+wheel width

The minimum TCR and Curb-to-Curb are measured with the steering wheel turned all the way to the lock position. A comparison of these minimums for left and right hand turns could reveal asymmetric conditions in the steering system which should be further investigated. The effect of modifications involving the wheels and tires or suspension geometry can be easily evaluated by comparing the minimum TCR or Curb-to-Curb before and after the change.

Another possibility to evaluate steering symmetry is to plot the three dimensional movement of the wheel relative to the body through a full steering sweep and compare the differences from side-to-side.

When the thrust angle of the vehicle is not in a straight ahead direction, a condition referred to as dog tracking may occur. In this condition, the front wheels have to be steered in the same direction and amount as the thrust angle to travel in a straight ahead direction. The condition looks like a vehicle's front wheels are not in line with the rear wheels when it is going down the road making the vehicle travel in a partially sideways manner. In one embodiment, a vehicle wheel alignment system is configured to determine if the body is out of line with the wheels by a given tolerance, and to identify the dog tracking condition to the alignment technician.

A calculation can be done to show how much of the road width will be taken up as a result of the dog tracking condition. Most countries, including the US, have a specification for how wide a vehicle's lane for a road should be. Using the vehicle wheelbase, the vehicle track width, and the amount of dog tracking measured for the vehicle, the overall vehicle dog tracking width can be calculated. The results of the dog tracking width measurement may be displayed to an operator as the amount of road width the vehicle is taking up. This could be given for a variety of different types of roads (example: interstate versus highways) and for countries.

This is especially important to heavy duty trucks where the long wheelbase means that a small amount of dog tracking equates to a larger amount of the road being taken up. Optionally, a bar graph or virtual view type of display could be used to show how much of the road a vehicle would take up due to the dog tracking.

The most common lane width in the United States is 3.658 m (144 inches). In one example, a passenger vehicle with 2.87 m (113 inches) for wheelbase and 1.651 m (65 inches) for track width is used. In a second example a heavy duty truck with 6.223 m (245 inches) for wheelbase and 1.651 m (95 inches) for track width is used. Both vehicles have a thrust angle of 2.0 degrees and no axle offset. The total amount of lane width used by the wheels due to dog tracking is shown below and calculated according to the following equation:

0.5*rear trackwidth+0.5*front trackwidth+wheelbase*tan(thrust angle)=vehicle lane width

### EXAMPLE 1a

### Audi A4

0.5*1651+0.5*1651+2870*tan(2)=1651+88.7=1751 mm

With no dog tracking, the vehicle's wheels take up 1651/3658*100=45% of the road's lane.

With dog tracking, the vehicle's wheels take up 1751/3658*100=48% of the road's lane.

### EXAMPLE 2a

### Class 8 Truck

0.5*2413+0.5*2413+6223*tan(2)=2413+217=2630 mm

With no dog tracking, the vehicle's wheels take up 2413/3658*100=66% of the road's lane.

With dog tracking, the vehicle's wheels take up 2630/3658*100=72% of the road's lane.

Body Overhang

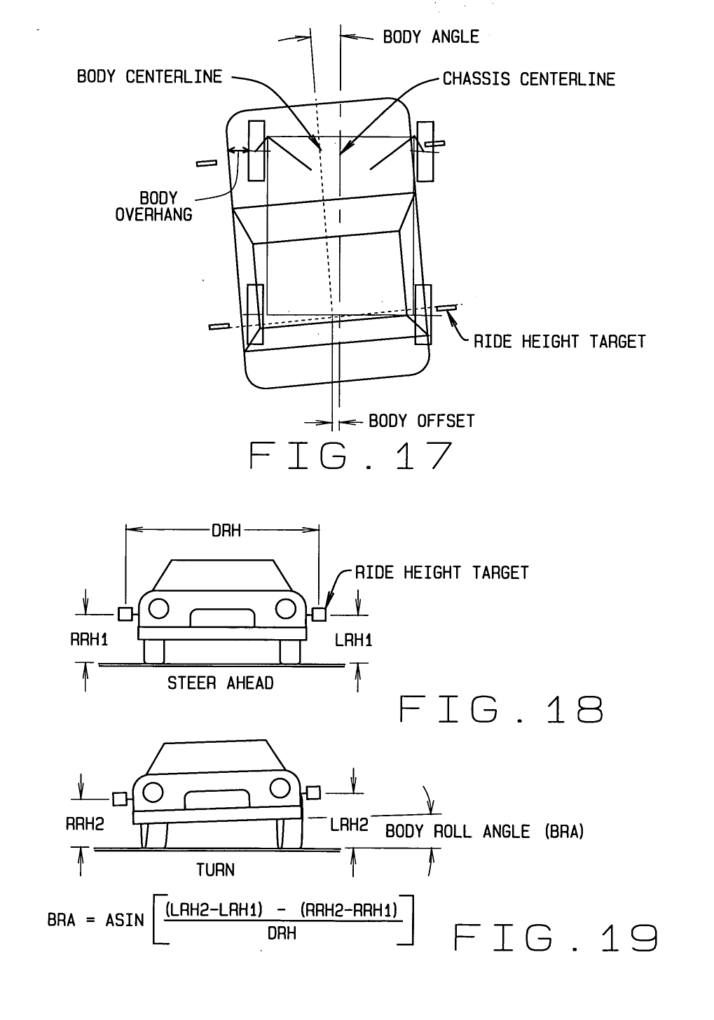

The amount of front body overhang and rear body overhang also affect this dog tracking condition, as may be seen in FIG. 17. The amount of overhang can be measured with a ride height target placed even with the front of the vehicle and even with the rear of the vehicle. Placing the ride height target with the current vision system will likely put it out of the FOV of the cameras. Having the target held by a person to get an estimate of the front overhang would not be very good because a person would have a difficult time holding the target steady and it doesn't come across as a very accurate measurement. The better implementation is to use a stand that can flexibly hold the target. The stand would ideally have a horizontal bar so that the stand's bar could be placed even with the front or rear bumper of the vehicle. A single snapshot of each bumper is enough to calculate the amount of overhang.

The vehicle length makes the vehicle lane width measurement larger. To illustrate, take the vehicle values from the examples above and include body overhang. For Example 1 above, use a front overhang of 914 mm (36 inches) and a rear overhang of 1067 mm (42 inches). For Example 2 above, use a front overhang of 1219 mm (48 inches) and a rear overhang of 1524 mm (60 inches).

### EXAMPLE 1b

### Audi A4

0.5*1651+0.5*1651+((2870+914+1067)*tan(2))=1651+169=1820 mm

With no dog tracking, the vehicle's wheels take up 1651/3658*100=45% of the road's lane.

With dog tracking, the vehicle's wheels take up 1820/3658*100=50% of the road's lane.

### EXAMPLE 2b

### Class 8 Truck

0.5*2413+0.5*2413+((6223+1219+1524)*tan(2))=2413+313=2726 mm

With no dog tracking, the vehicle's wheels take up 2413/3658*100=66% of the road's lane.

With dog tracking, the vehicle's wheels (body) take up 2726/3658*100=75% of the road's lane.

For any road lane, a thrust angle of 2 degrees is a difference of 1 foot in vehicle lane width for Example 2b. In one aspect of the present invention, the dog tracking handling condition is presented to an operator in a more useful way by taking some new body overhang measurements and presenting the dog tracking relative to road width. The measurement presentation to the user may provide user input for the minimum and maximum road widths in the customer's area for a customized presentation.

Wheel Load (From Weight Scales)

During a vehicle service procedure, the vehicle may be disposed on a supporting surface, such as turn plates or slip plates, which includes weight scales at each wheel location. With weigh scales at each wheel of a vehicle, the individual wheel loads can be directly determined and used in subsequent calculations. In the event that weigh scales are not available, a tire with a known spring rate is required for this measurement. Hunter Engineering DSP 9700 series balancers are capable of measuring the loaded spring rate of tires. The force on the tire is just the spring rate of the tire times the deflection under load. The measurement is accomplished by first determining the height of the wheel axis of rotation above the rolling plane. The vehicle is then jacked up slowly with the jacking points on the frame.

As the vehicle is raised, the wheel mounted target will indicate the amount of relaxation of the tire while the body mounted target will indicate the amount the vehicle is raised. The distance between the two targets will continually increase as long as the wheel is in contact with the rolling surface. The distance between the two will remain constant once the wheel breaks contact with the rolling surface which indicates the zero load height for the uncompressed tire. The height change between compressed and uncompressed tire positions is used to calculate the load on the wheel with the known spring rate.

With the addition of weigh scales integrated in the turn plates and slip plates the measurement of the static center of gravity location becomes more direct. The approximations involving tire stiffness are not required and vehicle lifting is no longer necessary except in the case of finding the height of the center of gravity of the vehicle. Optionally, the weight scales may be configured so that the position as well as the magnitude of the vehicle weight can be determined.

Body Roll Angle

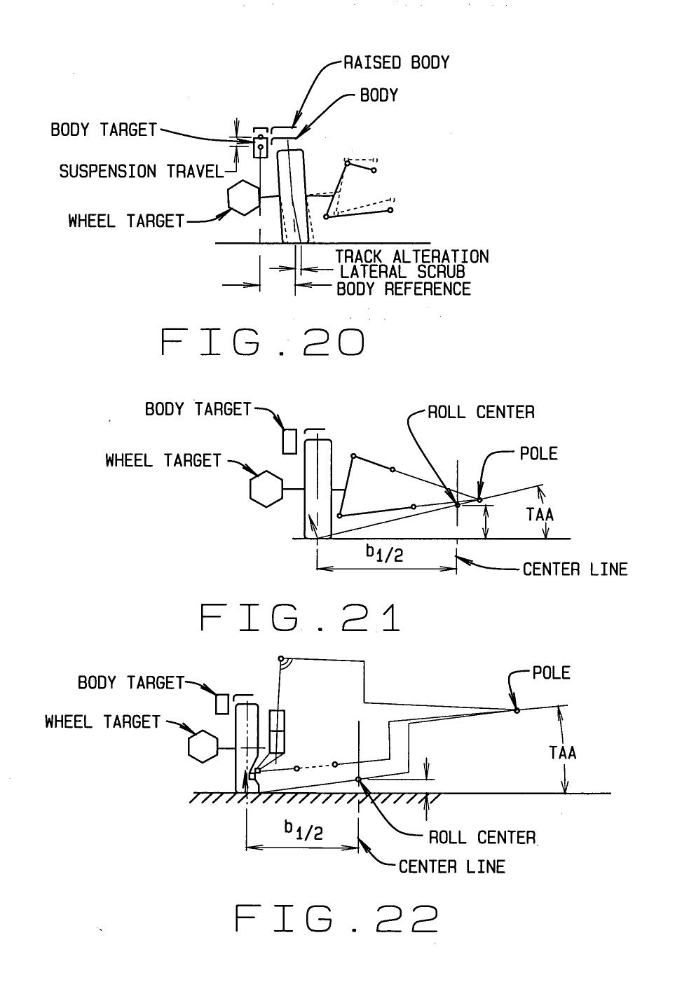

With reference to FIGS. 18 and 19, the use of ride height targets mounted to a vehicle body enable a vehicle wheel alignment system of the present invention to obtain a measurement of the body roll angle. When the vehicle is steered from side to side, the body of the vehicle rolls due to a height change induced by the steering axis inclination (SAI) and caster. The side of the vehicle on the inside of the turn is lifted higher than the side of the vehicle on the outside of the turn. A ratio can be formed by calculating the change in height on the left side minus the change in height on the right side and dividing the difference by the distance between the left and right targets. The arctangent of the above ratio is the body roll angle. Steering system and suspension symmetry can be measured by comparing the body roll angles at predefined steering angles such as the caster steer angles or at the steering lock. If the roll angle for the left turn is not the same in magnitude but opposite in sign of the roll angle for the right turn, a symmetry problem has been identified. Also the effectiveness of chassis modifications in reducing body roll can be evaluated using before and after measurements.

The tilt of the body fore and aft or left to right can be measured by computing the angle between the plane defined by a set of ride height targets mounted to the vehicle in proximity to the vehicle wheel wells, with the rolling surface reference plane or the plane defined by the individual wheel targets. If the vehicle body is jacked up at one end or on one side, the angular change in position can be determined by subtracting the angle defined by the plane of the ride height targets in the jacked position from the angle defined by the same plane un-jacked. This angle can be useful for diagnostics such as locating the height of the vehicle center of gravity.

To determine the dynamic behavior of the suspension system it is necessary to characterize the suspension geometry with respect to the body of the vehicle as well as the rolling surface. This is done by measuring in three dimensions points and/or angles on the body of the vehicle as well as the wheels. If the machine vision system is of the type that uses targets, additional targets are attached to the points of interest on the body of the vehicle as shown in FIGS. 17 and in FIG. 20. When the machine vision system does not require targets to measure the wheel angles, such as in a non-contact system, a separate area of interest in the field of view is used to measure a point on the body. In either case the additional body measurement allows a more complete characterization of the suspension system.

The following describes the additional measurements related to the vehicle suspension dynamic and/or static characteristics that become available with the addition of body position information derived in conjunction with the three dimensional positions of the wheel axis of rotation, steering axis and rolling surface including the wheel alignment angles.

Body Position and Centerline

Ideally the body centerline and chassis centerline of a vehicle are aligned with each other and with the thrust line of the vehicle. The body position may be questioned in the event of a collision or intentional modification. The result of a collision repair can also be assessed. With reference to FIG. 17, the body centerline is established by connecting the mid point of the two front ride height targets with the mid point of the two rear ride height targets. The alignment system of the present invention is configured to identify the chassis centerline of a vehicle by connecting the mid-point of the two front wheel target references with the mid-point of the two rear wheel target references. The body offset is defined as the lateral distance between the body mid point and the chassis mid point at the rear axle. The body angle is defined as the angle between the two centerlines as shown in FIG. 17. It is equivalent to measure both front and rear body offsets instead of one offset and an angle.

Track Alteration Angle

Within the context of the present invention, the track alteration angle is defined relative to the body of a vehicle, and represents the lateral movement of a wheel contact center with either suspension jounce or rebound, as shown in FIG. 20. In a method of the present invention, the vehicle is jacked up a short distance so that the wheels do not break contact with the slip plates or cause the slip plate travel to bottom out. A track alteration angle, TAA, is defined by dividing the lateral scrub by the amount the body is lifted and taking the inverse tangent. If the movement of the contact center is inboard the tangent will be positive. Alternatively, the same information can be obtained by lowering the vehicle body, such as by pulling it down or applying a vertical load.

Roll Center

A vehicle wheel alignment system of the present invention may be utilized to identify a vehicle roll center. The roll center can be determined for SLA, McPherson strut and swing axle suspensions. FIG. 21 illustrates the geometry for locating the roll center, R, of an SLA type suspension while FIG. 22 shows the geometry for the McPherson strut. First the pole or instant center of the linkage is established and then a line is drawn from the pole to the contact center. The vertical dimension for the intersection of the line with the vehicle centerline plane is the roll center height, hR0. It can be observed that the wheel movement at the contact center follows an arc whose center is the pole. The tangent to that arc at the contact center is measured by the track alteration angle (TAA) if the vertical body movement is kept small. Therefore, a line drawn through the contact center, normal to the track alteration angle, will pass through the roll center and the pole. The roll center height is then calculated by the alignment system as hR0=Tan(TAA)*bf/2. A positive value indicates the roll center is above the rolling surface while a negative value indicates the roll center is below the rolling surface.

Jacking-Based Bump Steer Curve

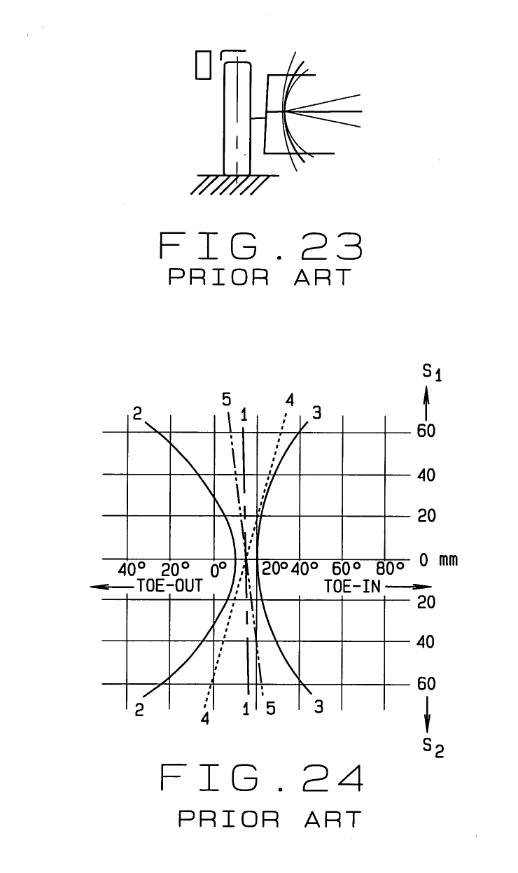

FIG. 23 illustrates the steering geometry changes in a vehicle wheel when the inner joint of the tie rod or rack and pinion is located too high (position 4), or too low (position 5). The effect of the miss-location is plotted on the graph of FIG. 24. Curve 1 is the nominal position showing no change in the toe angle as the suspension travels in jounce and rebound. Curve 4 is generated when the tie rod end is too high and curve 5 when it is too low. When the tie rod or rack and pinion is not level, at least one end is either too high or too low. The condition can be diagnosed by observing the toe angle change of each front wheel as the body moves up and down. When the tie rod end is properly positioned the toe angle will not change with body movement. If one or both ends are out of position, the difference in toe change from side to side will cause the vehicle to steer as the body is raised or lowered. The side with the high inner joint (or low outer joint) will have a greater toe change in the negative direction as the vehicle body is raised. In the event that both ends are high or low the tie rod will be level and no change in steer will be observed. However, monitoring the individual toe angles will reveal a high slope in the toe change curve. The slope is calculated by dividing the toe change by the change in height of the body. A threshold can be applied to the slope value to indicate an off nominal position of the tie rod or rack and pinion.

The alignment system of the present invention captures alignment angles, alignment distances, and vehicle weight (from weight measuring turnplates) as the vehicle is jacked up or lowered. The data collected (change in alignment angle vs. change in ride height) is used to establish a trend line algorithm for each of the alignment angles captured. Movement of an angle (caster, camber, toe, wheel base) on one side of the vehicle is compared to the equivalent angle on the opposite side of the vehicle to see if the angle movements are symmetrical within a given tolerance. This comparison is useful in diagnosing vehicle bump steer conditions. The data for a selected angle is also analyzed for discontinuity. A detected discontinuity is an indicator of worn parts that abruptly change as the vehicle is jacked. The data is also used for subsequent calculations of suspension and chassis properties such as bump steer, roll center, anti-dive and anti-squat.

In one embodiment, vehicle ride height targets attached to the vehicle are utilized to provide a measure of vehicle height change. Other methods could be used to determine when the vehicle's height is changing as a result of raising the axle and by how much the height is changing. For example, an alternative means to measure vertical height is the use of an optical encoder and a string where one end of the string is attached to the frame of the vehicle and the other end is attached to the rotating shaft of the position fixed optical encoder in such a way as to rotate the shaft as the string end attached to the frame is moved further from the optical encoder. The preferred method is to use the ride height targets because they provide a stable, accurate measurement of the height of the vehicle.

In one embodiment, captured data is plotted and displayed for visual comparison by the user. The data can also be programmatically evaluated to determine if a bump steer condition exists and whether a suitable indication to the user of the condition can be made. For example, the data may be displayed in the form of a bar graph indicating the difference in the alignment angles as the wheels leave the supporting surface. Another suitable means is a warning that a bump steer condition exists due to alignment angle differences such as toe between the left and right side. Another suitable means is a plot of the vehicle height versus the alignment angle.

As part of the procedure for measuring bump steer, it is advantageous if the front wheels were not steered as the vehicle's axle is jacked up. This could be handled by placing a steering wheel holder in the vehicle as the vehicle's front wheels are steered ahead. Another way to handle this is to compensate the toe as the vehicle is being jacked up. If the vehicle's wheels start naturally steering to the left or right as the front axle is jacked up, both the left and right wheels can be adjusted for equal amounts of toe change detected to the steered left or right position. Another way to compensate for the vehicle's natural tendency to steer while being jacked is to use a steering wheel angle sensor. The amount of change in the steering wheel can compensate the amount of toe change detected at the wheels.

Note that fast acquisition times for capturing the alignment angles as the axle is being jacked is an advantage in this invention. It is helpful to have at least four alignment angle acquisitions from the time an alignment angle starts moving in reaction to the axle being jacked to the time the alignment angle stops moving as a result of the wheel breaking contact with the supporting surface.

Preferably, the ride height targets are mounted so that they are closer to the wheel targets because the field of view of the observing cameras may be reduced when both ride height and wheel targets must be observed in a single field of view while the axle is jacked up and down.

Roll Steer

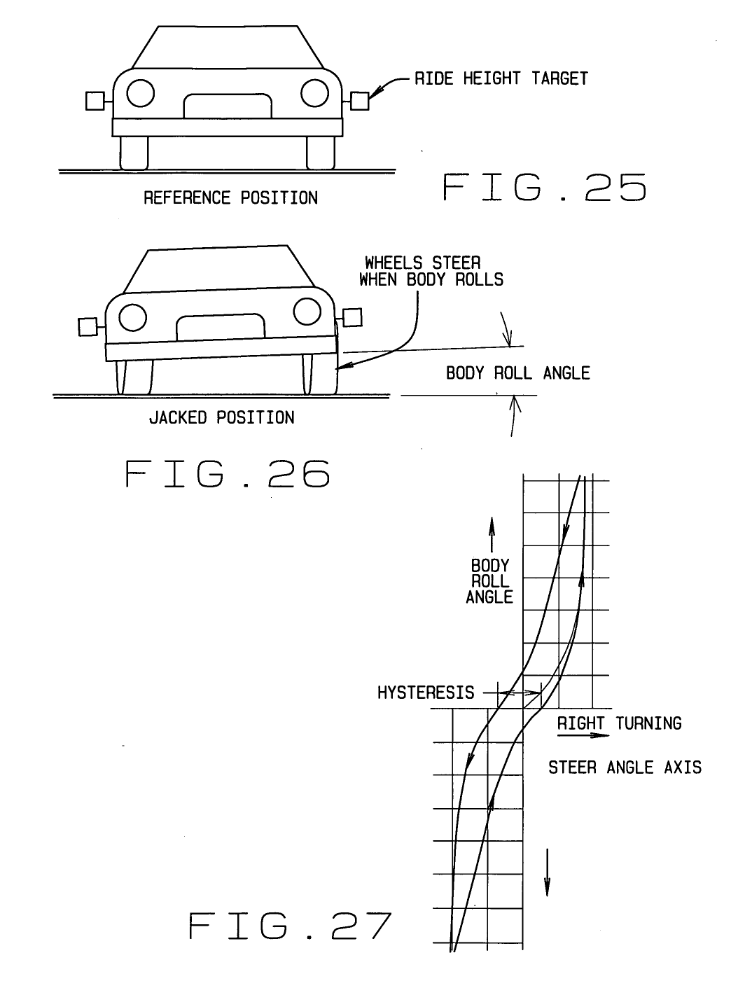

With reference to FIGS. 25 and 26, the tendency of the vehicle to steer as the body rolls can be measured in an alignment system of the present invention by plotting the steer ahead of the vehicle as a function of the body roll angle. Body roll can be induced by jacking one side of the vehicle using the body hard points. Both clockwise (CW) and counter clockwise (CCW) roll can be induced and symmetry evaluated. The roll steer diagnostic provides a means to evaluate stability of the vehicle in cross winds.

Suspension Auto-Leveling Check

The function of automatic leveling systems can be diagnosed with an alignment system of the present invention by comparing ride height measurements before and after loading the vehicle asymmetrically. A properly operating system will return to its unloaded position within a small tolerance after the load is applied.

Track Width-to-Body Ratio

The alignment system of the present invention may be configured to provide a measure of the track width ratio of a vehicle. A measurement of the track width acquired using the wheel targets is divided by a measurement of the vehicle width acquired using the ride height targets to provide the track width ratio. When a vehicle is modified (i.e. different wheels resulting in different track widths) the ratio is changed. Generally the ratio should be as large as possible to reduce the amount of body roll.

Wheelbase-to-Body Ratio

The alignment system of the present invention may be configured to provide a measure of the wheel base ratio of a vehicle. A measurement of the wheel base acquire using the wheel targets divided by a measure of the vehicle length acquired using ride height type of targets placed at the front and rear of the vehicle gives a wheel base ratio. A larger ratio normally gives better weight distribution for the vehicle as well as a softer ride because softer springs can be used for the suspension. A smaller ratio has a positive effect of tighter turning.

Steering Hysteresis

FIG. 27 is a plot of a vehicle body roll angle on the vertical axis against steering angle on the horizontal axis which may be obtained using an alignment system of the present invention. If the vehicle steering system is in good condition the hysteresis will be small and the zero crossings of the body roll angle with the steer axis will be symmetric. It is desirable but not necessary to plot the full curve to determine the hysteresis. An alternative is to take the difference between a first reading of the steer angle after steering from straight ahead to full right lock and back to zero body roll and a second reading of the steer angle after continuing the above steer to full left lock and returning to zero body roll. Unusually large hysteresis is an indication of a binding suspension member.

Another possibility for measuring hysteresis is to compare the vehicle body roll angles at zero degree steer. A first reading is taken after steering to the full lock in a right turn and returning to zero steer in the left turn direction. A second reading is taken after continuing in the left turn to the full lock and then returning to zero in the right turn direction. The difference in the body roll angles at the zero degree steer points is an alternate measure of the hysteresis.

With the steerable wheels resting on locked turn plates, and a steering wheel angle sensor attached to the steering wheel, the amount of steering wheel movement necessary to create a toe change can be measured by an alignment system of the present invention. The initial steering wheel movement is related to the amount of windup and play in the steering system. It is useful for diagnosing asymmetrical steering conditions and finding loose components.

Optionally, hysteresis may be measured with the steerable wheels resting on locked turn plates. A steering wheel angle sensor attached to the steering wheel reads the amount of steering wheel movement necessary to create a toe change. The initial steering wheel movement before a toe change is observed is related to the amount of windup and play in the steering system. It is useful for diagnosing asymmetrical steering conditions and finding loose components.

Jounce and Rebound Travel

Rebound travel can be measured with an alignment system of the present invention by first measuring the ride height of the vehicle as it sits in a static position on the rolling surface and then by acquiring a second ride height measurement after lifting the vehicle by the body until the wheels are free of the rolling surface. The difference in the first and second reading is the rebound travel of the suspension.

Jounce is measured similar to rebound. The ride height reading with the vehicle pulled down to the suspension stops is subtracted from the first ride height reading with the vehicle in a static position. Care should be taken to make sure the slip plate travel does not bottom out before the suspension travel limit is reached.

Weigh scales at each wheel can also be used to determine the limits of the suspension travel. For rebound, the ride height measurement is taken when the load on the scale is zero. For jounce, the measurement is taken when the slope of the ride height vs. image frame number curve changes abruptly.

Chassis Spring Rate

With a known wheel load and a known amount of wheel movement with respect to the body, the chassis spring rate may be calculated by the alignment system by dividing the load by the total relative movement between wheel and body. This is the effective spring rate which differs from the actual spring rate unless the chassis spring force is applied directly in line with the tire contact center. The measurement is useful in finding weak springs and assessing the effectiveness of suspension modifications or repair.

Center of Gravity

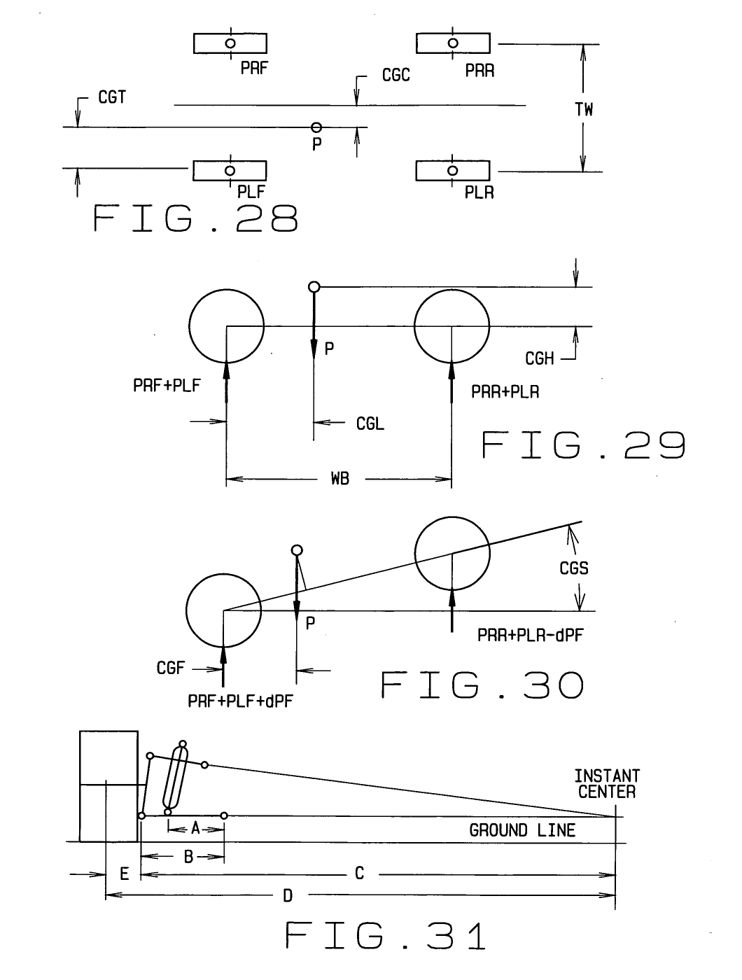

The location of the vehicle center of gravity can be calculated by the alignment system utilizing known or measured loads on the wheels and their locations. Referring to FIGS. 28-30, and to FIG. 29 in particular, the distance CGL is the location of the center of gravity with the front wheel as a reference point. The distance is calculated by the formula:

$$CGL = WB * ( 1 - \frac{PRF + PLF}{P} )$$

where:
CGL is the location of the center of gravity aft of the front wheel;
WB is the wheel base of the vehicle;
PRF is the load on the right front wheel;
PLF is the load on the left front wheel;
P is the sum of PRF+PLF+PRR+PLR;
PRR is the load on the right rear wheel; and
PLR is the load on the left rear wheel.

Referring to FIG. 28, the distance CGC can be calculated by the formula:

$$CGC = TW * ( ( \frac{PLF + PLR}{P} ) - \frac{1}{2} )$$

where:
CGC is the CG location with respect to the centerline of the vehicle with the positive direction is to the left; and
TW is the track width of the vehicle.

The height of the center of gravity can be found but the vehicle must be tilted to a known angle as shown in FIG. 30. Once tilted the following formula can be applied:

$$CGH * sin ( CGS ) = cos ( CGS ) * ( WB * ( \frac{PRF + PLF + dPF}{P} ) - 1 + CGL$$

where:
CGH is the height of the CG above the wheel centerline;
CGS is the tilt angle of the vehicle; and
dPF is the additional load applied to the front wheels due to the tilt.

Loose Suspension Components

The alignment system of the present invention may optionally be utilized to facilitate the identification of loose suspension components on a vehicle if a means to push the vehicle in the fore-aft direction and/or in the left-right direction is provided. With the slip plates pinned and the breaks locked the load is slowly applied to a hard point on the under carriage of the vehicle. The alignment system then compares the position of the ride height targets to the wheel targets as the load increases. At the end of the loading cycle those wheels that exhibited excessive movement with respect to their corresponding ride height target are candidates for further inspection to identify the loose components. If a wheel exhibits a sudden step movement as the load slowly increases, a loose or worn part is definitely indicated. It is possible to process one wheel at a time by not pinning the other three slip plates. One axle at a time can be done by unpinning the slip plates on the opposite axle.

An alternative method for loading the suspension in a sideways direction is to use Power Slide™ turn plates which have built in actuators. These turn plates are available from Hunter Engineering Co. in Bridgeton, Mo. The actuators are capable of generating high loads in a lateral direction. If any of the alignment angles show a sudden shift as the load is applied a loose or worn part is indicated.

Toe Compliance and Caster Compliance

Static toe specs are sometimes generated by the OEM with the goal of achieving a zero toe angle setting at the cruising speed of the vehicle (zero dynamic toe). This value is strongly influenced by the rear-to-front forces produced by tire rolling resistance and/or drive torque. To measure dynamic toe, a procedure of the present invention initially requires completing a set of traditional alignment measurements. After completing the set of traditional alignment measurements, the front tires of the vehicle are rolled up onto wedges whose slope produces a rear-to-front force similar to normal driving conditions. Alternatively, the pinned front turnplate could be tilted front-to-back or side-to-side to induce loads in the suspension. With the emergency brake on the vehicle set to lock the rear wheels, the toe angles are re-measured using the previous compensation values. This should produce a relatively small change in toe and should yield a value closer to the dynamic toe value. The change should be comparable on left and right sides, if suspension is operating properly.

This procedure can also be viewed as a quantitative version of shaking the wheel by hand to find degraded suspension parts. It can be repeated with the wedges flipped 180 degrees to reverse the forces and check for excess motion in the opposite direction. The Power Slide™ turn plates can also be used to load the suspension a controlled amount by regulating the air pressure to them.

Caster compliance is an angular measurement which is similar to toe compliance. Measurement procedures to determine caster compliance utilize shallow wedges turned sideways under the wheels on one side of the vehicle. Preferably, a slip plate is disposed on top of the wedge to allow a degree of wheel movement in response to the surface angle.

Cornering Camber and Cornering TFT

Cornering camber is the camber value at a selected fixed nonzero steering angle. The fixed steering angle is selected by observing steering angles visited by a wide range of vehicles during high speed maneuvering. The cornering camber angle is relative to vertical in the direction of the wheel plane of rotation, not relative to the car body.

This produces a number that describes the attitude of the tire while cornering, and therefore relates to how well it adheres to the road. It is also an alternative to estimating a single fixed steering axis in the presence of spring motion, and gets around problem situations like the Audi 8-point suspension.

When a vehicle is cornering hard, weight is shifting from wheels on one side of the vehicle to the wheels on the other side of the vehicle. By jacking up (or pulling down) the vehicle with the wheels steered, an alignment system of the present invention can acquire representative data from which curves can be plotted. One sided jacking may be necessary where torsion bar suspensions are used. These curves are then be used to predict the camber and toe values that will be produced during hard cornering, by estimate the amount of weight shift from one side to the other, and picking the appropriate points on the left and right curves. Other advanced suspension measurements can also be made with the wheels in this attitude, to provide additional data on steering forces and other parameters during cornering.

Cornering total front toe (TFT) is similar to cornering camber, and represents a total front toe value while steered.

Linkage Ratio for Spring Calculations

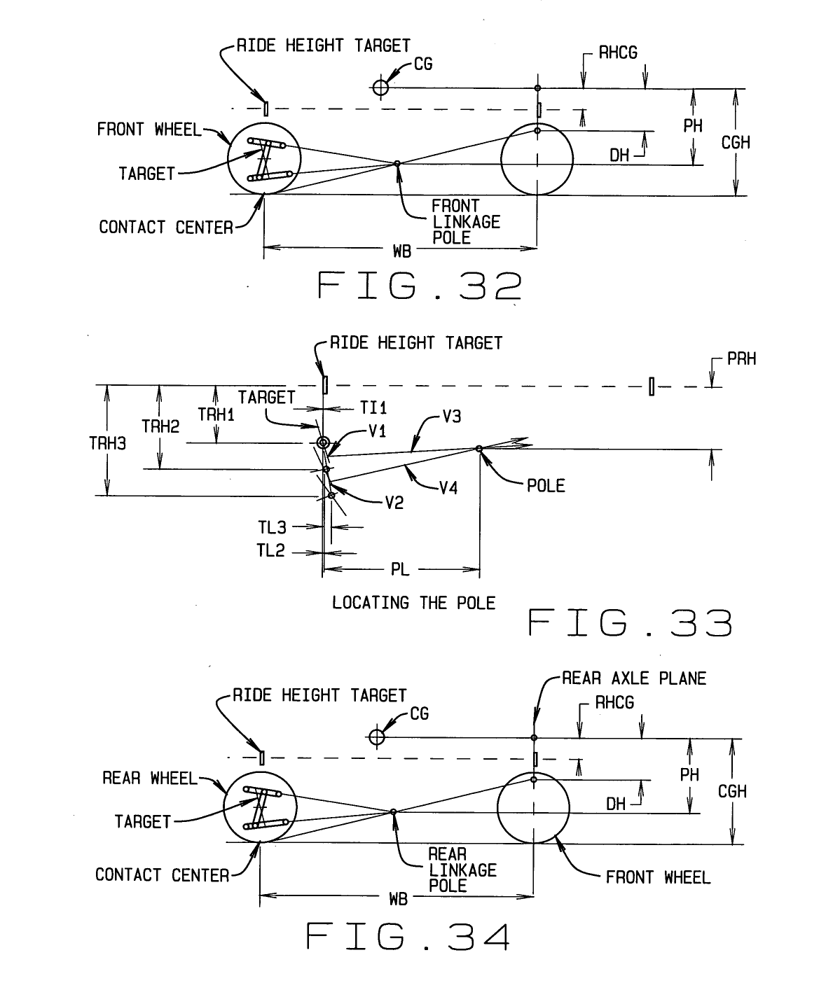

FIG. 31 illustrates the geometry for determining the linkage ratio for a spring associated with a vehicle wheel suspension system. The ratio (LnkR) is defined as the spring rate at the wheel divided by the spring rate of the spring by its self, and may be calculated by the alignment system of the present invention according to:

$$LnkR = {( \frac{A}{B} )}^{2} * {( \frac{C}{D} )}^{2}$$

The dimensions A and B can be measured manually and input into the alignment system of the present invention for use in the formula. Dimension C corresponds to dimension D-E where E can also be measured manually and input to the alignment system. The position of the instant center can be found by observing the arc the wheel target follows as the body is raised or lowered.

It can be seen that the ratio (C/D)² is close to 1. Dropping this term from the equation will produce an approximate result sufficiently accurate for most purposes.

$$LnkR ≅ {( \frac{A}{B} )}^{2}$$

Anti-Dive and Anti-Squat

Anti-Dive is a measure of how well the suspension geometry prevents the front of the car from going down when the brakes are applied, and can be measured using an alignment system of the present invention. FIG. 32 and FIG. 33 illustrate the geometrical concepts for the calculation. The procedure for acquiring the anti-dive measurement requires finding the front linkage pole and drawing a line from the contact center through the pole and intersecting the rear axle plane. The intersection point is the vertical distance DH from the CG location. Anti-Dive is expressed in an alignment system of the present invention by the equation:

$$Antidive = 1 - ( \frac{DH}{CGH} )$$

When DH is zero, Anti-Dive is 100%, meaning the front of the vehicle will not change height under braking. FIG. 33 illustrates how the pole is located. First measurements TL1 and TRH1 are taken with the vehicle at normal ride height. The body of the vehicle is slowly raised a short distance and measurements TL2 and TRH2 are taken. The body is raised slightly again and measurements TL3 and TRH3 are taken. Vector V1 is constructed from points (TL1, TRH1) and (TL2, TRH2) and vector V2 is constructed from points (TL2, TRH2) and (TL3, TRH3). Vector V3 is a perpendicular bisector of vector V1 in the direction of the rear wheel, and vector V4 is a perpendicular bisector of vector V2 in the direction of the rear wheel. The intersection of vectors V3 and V4 defines the approximate location of the pole. It will be noted that the linkage angles will change as the vehicle body is raised moving the pole. If the body displacements can be kept small a good estimate of the position of the pole is possible. The dimension DH is determined by an alignment system of the present invention using the equation:

$$DH = CGH * ( 1 - \frac{WB}{PL} ) + ( PH * \frac{WB}{PL} )$$

where:

PH=PRH+RHCG

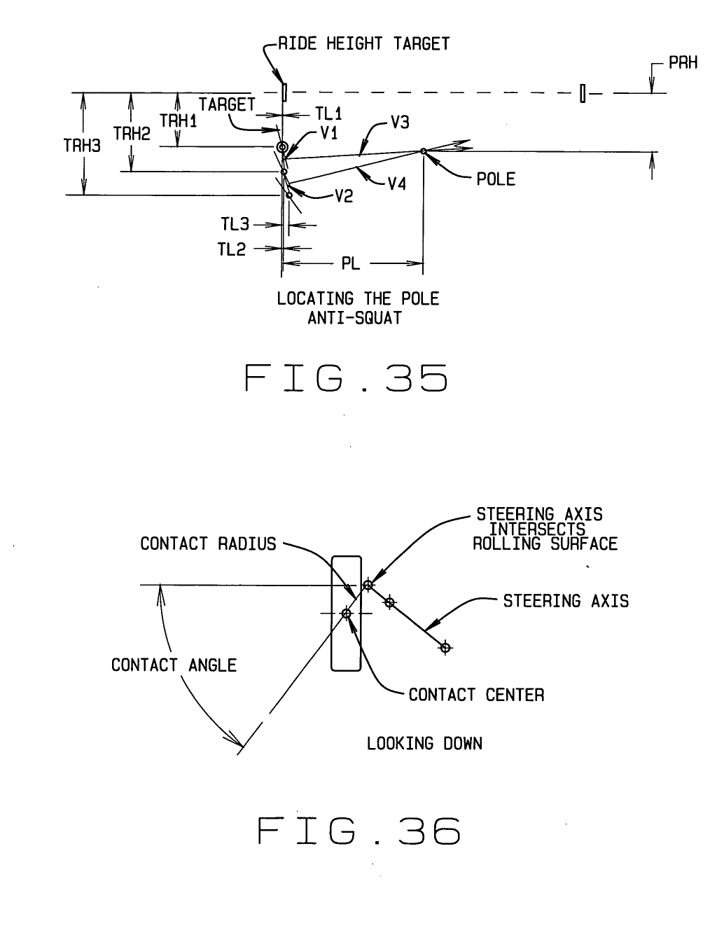

Anti-Squat is identical to Anti-Dive except the equations above are applied to the measurements for the rear wheel and the pole for the rear suspension is found, as shown in FIGS. 34 and 35. It is not uncommon for performance vehicles to have Anti-Squat greater than 100%. In this case the rear of the vehicle lifts when accelerating. If the length PL gets too short, rear wheel hop when braking is introduced and a warning can be provided.

Contact Radius:

Using an alignment system of the present invention, the contact radius of a wheel may be measured. The length of the line segment between the wheel contact center and the steering axis intersection with the rolling surface defines a contact radius, CR, as is illustrated in FIG. 36. Associated with the contact radius is the contact angle, CA. It is the angle between the line defined by the contact radius and a line transverse to the vehicle centerline.

The present disclosure can be embodied in-part in the form of computer-implemented processes and apparatuses for practicing those processes. The present disclosure can also be embodied in-part in the form of computer program code containing instructions embodied in tangible media, such as floppy diskettes, CD-ROMs, hard drives, or an other computer readable storage medium, wherein, when the computer program code is loaded into, and executed by, an electronic device such as a computer, micro-processor or logic circuit, the device becomes an apparatus for practicing the present disclosure.

The present disclosure can also be embodied in-part in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the present disclosure. When implemented in a general-purpose microprocessor, the computer program code segments configure the microprocessor to create specific logic circuits.

As various changes could be made in the above constructions without departing from the scope of the disclosure, it is intended that all matter contained in the above description or shown in the accompanying drawings shall be interpreted as illustrative and not in a limiting sense.

1. An improved vehicle wheel alignment system for acquiring measurements associated with a vehicle using image data received from an image acquisition system, comprising:
a processing system configured to receive image data associated with a position and orientation of a vehicle wheel assembly and an associated steering axis;
wherein said processing system is configured to process said received image data to identify at least one point in a contact patch plane of said wheel assembly, and a position and orientation of said associated steering axis; and
wherein said processing system is further configured to utilize said at least one identified point in said contact patch plane, and said position and orientation of said associated steering axis to determine and store a measure of a force moment arm associated with said vehicle wheel assembly.

2. The improved vehicle wheel alignment system of claim 1 wherein said force moment arm is a braking force moment arm.

3. The improved vehicle wheel alignment system of claim 2 wherein said processing system is configured to determine a contact patch center point for said wheel assembly, said contact patch center point defined as the mid-point between a leading contact point of said contact patch and a trailing point of said contact patch; and
wherein said braking force moment arm is determined as the perpendicular distance between said associated steering axis and said contact patch center point.

4. The improved vehicle wheel alignment system of claim 1 wherein said force moment arm is a lateral force moment arm.

5. The improved vehicle wheel alignment system of claim 4 wherein said lateral force moment arm is determined by said processing system as the shortest perpendicular distance between a projection of said associated steering axis onto a longitudinal plane of the vehicle and a projection of said contact patch center point onto said longitudinal plane, said contact patch center point defined as the mid-point between a leading contact point of said contact patch and a trailing point of said contact patch.

6. The improved vehicle wheel alignment system of claim 1 wherein said at least one identified point in said contact patch plane is a contact patch center point.

7. A method for acquiring force moment arm measurements associated with a vehicle wheel assembly using image data received from an image acquisition system, comprising:
acquiring image data associated with a position and orientation of a vehicle wheel assembly and an associated steering axis;
processing said received image data to identify at least one point in a contact patch plane of said wheel assembly;
processing said received image data to identify a position and orientation of said associated steering axis; and
determining and storing a measure of a force moment arm associated with said vehicle wheel assembly utilizing said at least one identified point in said contact patch plane and said position and orientation of said associated steering axis.

8. The method of claim 7 wherein said force moment arm is a braking force moment arm.

9. The method of claim 8 further including the step of locating a contact patch center point for said wheel assembly, said contact patch center point located as a mid-point between a leading contact point of said identified contact patch surface and a trailing point of said identified contact patch surface; and
wherein said braking force moment arm is determined as a perpendicular distance between said associated steering axis and said located contact patch center point.

10. The method of claim 7 wherein said force moment arm is a lateral force moment arm.

11. The method of claim 10 further including the step of locating a contact patch center point for said wheel assembly, said contact patch center point located as a mid-point between a leading contact point of said identified contact patch surface and a trailing point of said identified contact patch surface; and
wherein said lateral force moment arm is calculated as the shortest perpendicular distance between a projection of said associated steering axis onto a longitudinal plane of the vehicle and a projection of said contact patch center point onto said longitudinal plane.

12. The improved vehicle wheel alignment system of claim 7 wherein said at least one identified point in said contact patch plane is a contact patch center point.

13. A method for determining a tire contact patch center point using a machine vision wheel alignment system
acquiring image data representative of a wheel assembly;
determining leading and trailing contact points for a contact patch associated with the wheel assembly from said acquired image data;
identifying a mid-point between said leading and trailing contact points, said identified mid-point corresponding to a contact patch center point for said wheel assembly.

14. The method of claim 13 wherein said step of determining said leading and trailing contact points further includes determining an estimated loaded radius for said wheel assembly.

15. The method of claim 14 wherein said estimated loaded radius is determined as a percentage of said unloaded radius for said wheel assembly.

16. The method of claim 13 further including the step of determining an effective tire circumference for said wheel assembly, said effective tire circumference determined by:
acquiring data representative of an first position of said wheel assembly;
acquiring data representative of a second position of said wheel assembly after rolling movement thereof;
processing said acquired data representative of said first and second positions of said wheel assembly to measure a distance (P) travelled by said wheel assembly during said rolling movement;
processing said acquired data representative of said first and second positions of said wheel assembly to measure degrees of rotational movement (δ) of said wheel assembly during said rolling movement; and
calculating and storing an effective tire circumference (ETC) value for said wheel assembly according to the relationship:
$$ETC = \frac{360 \times P}{δ} .$$

17. The method of claim 16 wherein an unloaded radius for said wheel assembly is calculated as a percentage of said effective tire circumference for said wheel assembly.
